(19) United States
(12) Patent Application Publication
(10) Pub. No.: US 2019/0205655 A1
(43) Pub. Date: Jul. 4, 2019

(54) INFANT MONITORING SYSTEM WITH VIDEO-BASED TEMPERATURE BASELINING AND ELEVATED TEMPERATURE DETECTION

(71) Applicant: Google LLC, Mountain View, CA (US)

(72) Inventors: Yoky Matsuoka, Los Altos Hills, CA (US); Shwetak Patel, Seattle, WA (US); Michael Dixon, Sunnyvale, CA (US)

(73) Assignee: Google LLC, Mountain View, CA (US)

(21) Appl. No.: 15/859,650

(22) Filed: Dec. 31, 2017

(51) Int. Cl. G06K 9/00; G06K 9/32; H04N 5/33

(52) U.S. Cl. CPC G06K 9/00771; G06K 9/00228; H04N 5/33; G06K 9/32; G06K 9/00926; G06K 9/00288

(57) ABSTRACT

A method of monitoring physical characteristics of subjects in sleep environments may include receiving, through a video camera, a video feed of a subject in a sleep environment, where the video camera may include a thermal imaging camera, and where the video feed may include thermal images of a face of the subject. The method may also include establishing a baseline thermal signature of the face of the subject. The method may additionally include identifying a thermal anomaly by comparing the baseline thermal signature to a current thermal image of the face of the subject. The method may further include identifying a condition of the subject based on the thermal anomaly.

### CROSS REFERENCE TO RELATED APPLICATIONS

This patent application is related to U.S. patent application Ser. No. 15/859,640, entitled “ENHANCED VISUALIZATION OF BREATHING OR HEARTBEAT OF AN INFANT OR OTHER MONITORED SUBJECT” filed concurrently with the present application on Dec. 31, 2017 (Attorney Docket No. 094021-1064573), which is hereby incorporated by reference in its entirety for all purposes.

This patent application is also related to U.S. patent application Ser. No. ______, entitled “ENHANCED VISUALIZATION OF BREATHING OR HEARTBEAT OF AN INFANT OR OTHER MONITORED SUBJECT” filed concurrently with the present application on Dec. 31, 2017 (Attorney Docket No. 094021-1064637), which is hereby incorporated by reference in its entirety for all purposes.

### TECHNICAL FIELD

This patent specification relates generally to a smart-home environment for monitoring subject. More particularly, this patent specification describes automatic control of smart-home devices, such as video camera assemblies, keypads, security system sensors, thermostats, hazard detectors, doorbells, and/or the like, to create an optimal sleep environment for a monitored subject.

### BACKGROUND

Smart-home devices are rapidly becoming part of the modern home experience. These devices may include thermostats, keypads, touch screens, and/or other control devices for controlling environmental systems, such as HVAC systems or lighting systems. The smart-home environment may also include smart appliances, such as washing machines, dishwashers, refrigerators, garbage cans, and so forth, that interface with control and/or monitoring devices to increase the level of functionality and control provided to an occupant. Security systems, including cameras, keypads, sensors, motion detectors, glass-break sensors, microphones, and so forth, may also be installed as part of the smart-home architecture. Other smart-the home devices may include doorbells, monitoring systems, hazard detectors, smart lightbulbs, and virtually any other electronic device that can be controlled via a wired/wireless network.

Many modern smart-home environments may include video cameras. These video cameras may be used for security systems, monitoring systems, hazard detection systems, and so forth. In general, video cameras provide a live video feed that can be played at a local console or on a computing system of the user, allowing them to remotely monitor a portion of the smart-home environment or its surroundings.

### BRIEF SUMMARY

In some embodiments, a method of monitoring physical characteristics of subjects in sleep environments may include receiving, through a video camera, a video feed of a subject in a sleep environment, where the video camera may include a thermal imaging camera, and where the video feed may include thermal images of a face of the subject. The method may also include establishing a baseline thermal signature of the face of the subject. The method may additionally include identifying a thermal anomaly by comparing the baseline thermal signature to a current thermal image of the face of the subject. The method may further include identifying a condition of the subject based on the thermal anomaly.

In some embodiments, a system for monitoring physical characteristics of subjects in sleep environments may include a video camera, one or more processors, and one or more memory devices comprising instructions that, when executed by the one or more processors, cause the one or more processors to perform operations including receiving, through the video camera, a video feed of a subject in a sleep environment, where the video camera may include comprises a thermal imaging camera, and where the video feed may include thermal images of a face of the subject. The operations may also include establishing a baseline thermal signature of the face of the subject. The operations may additionally include identifying a thermal anomaly by comparing the baseline thermal signature to a current thermal image of the face of the subject. The operations may further include identifying a condition of the subject based on the thermal anomaly.

A further understanding of the nature and advantages of the present invention may be realized by reference to the remaining portions of the specification and the drawings. Also note that other embodiments may be described in the following disclosure and claims.

### BRIEF DESCRIPTION OF THE DRAWINGS

FIG. 1 is an example of a smart-home environment within which one or more of the devices, methods, systems, services, and/or computer program products described further herein will be applicable, according to some embodiments.

FIG. 2A illustrates a simplified block diagram of a representative network architecture that includes a smart-home network in accordance, according to some embodiments.

FIG. 2B illustrates a simplified operating environment in which a server system interacts with client devices and smart devices, according to some embodiments.

FIG. 3 illustrates a block diagram of a representative smart device in accordance with some implementations.

FIG. 4A illustrates a view of a representative camera assembly in accordance with some implementations.

FIG. 4B illustrates a view of a representative camera assembly in accordance with some implementations.

FIG. 5A is an expanded component view of a representative camera assembly in accordance with some implementations.

FIG. 5B is an expanded component view of a representative camera assembly in accordance with some implementations.

FIG. 6 illustrates an infant sleeping in a sleep environment and being monitored by a camera, according to some embodiments.

FIG. 7 illustrates a view of the infant that may be received by the camera, according to some embodiments.

FIG. 8 illustrates an image similar to that of FIG. 7 captured by the thermal imager function of the camera, according to some embodiments.

FIG. 9 illustrates a thermal view and of the infant with a bounding box that reduces the processing power, memory, and/or bandwidth required by the system, according to some embodiments.

FIG. 10 illustrates a thermal image that can diagnose an infant that is to cold, according to some embodiments.

FIG. 11 illustrates a thermal image that can be used to diagnose an infant who is teething, according to some embodiments.

FIG. 12 illustrates a thermal image that can be used to diagnose an infant who is suffering from a fever, according to some embodiments.

FIG. 13 illustrates a system diagram for processing and transmitting images between the camera and a user's mobile device, according to some embodiments.

FIG. 14A illustrates a representation of the live video feed displayed on a mobile device, according to some embodiments.

FIG. 14B illustrates a representation of the thermal video feed as it is displayed on a mobile device.

FIG. 15 illustrates an indication that indicates automatic environmental changes that have been executed by the smart-home environment based on the thermal images received from the camera, according to some embodiments.

FIG. 16 illustrates an alternative visual representation of an alert on a mobile device, according to some embodiments.

FIG. 17 illustrates a simplified flowchart of a method for monitoring physical characteristics of subjects in sleep environments.

### DETAILED DESCRIPTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure. It will be apparent to one skilled in the art that the present invention may be practiced without some or all of these specific details. In other instances, well known details have not been described in detail in order not to unnecessarily obscure the present invention.

In addition, for clarity purposes, not all of the routine features of the embodiments described herein are shown or described. One of ordinary skill in the art would readily appreciate that in the development of any such actual embodiment, numerous embodiment-specific decisions may be required to achieve specific design objectives. These design objectives will vary from one embodiment to another and from one developer to another. Moreover, it will be appreciated that such a development effort might be complex and time-consuming but would nevertheless be a routine engineering undertaking for those of ordinary skill in the art having the benefit of this disclosure.

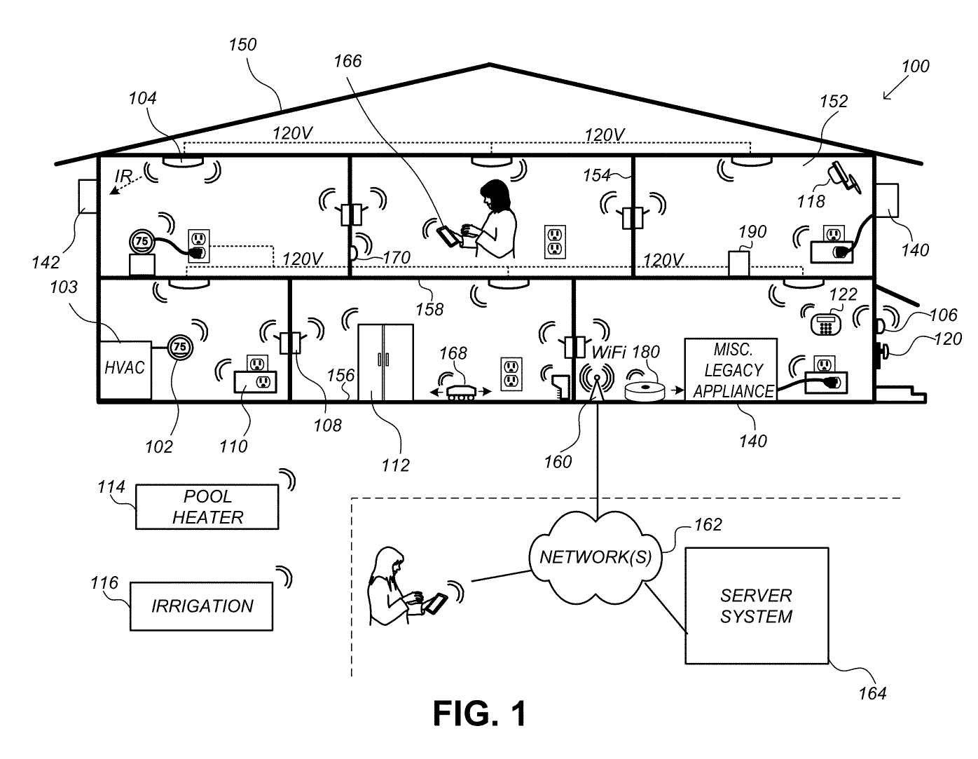

FIG. 1 illustrates an example smart-home environment 100, according to some embodiments. The smart-home environment 100 includes a structure 150 (e.g., a house, office building, garage, or mobile home) with various integrated devices. It will be appreciated that devices may also be integrated into a smart-home environment 100 that does not include an entire structure 150, such as an apartment, condominium, or office space. Further, the smart-home environment 100 may control and/or be coupled to devices outside of the actual structure 150. Indeed, several devices in the smart-home environment 100 need not be physically within the structure 150. For example, a device controlling a pool heater 114 or irrigation system 116 may be located outside of the structure 150.

The term “smart-home environment” may refer to smart environments for homes such as a single-family house, but the scope of the present teachings is not so limited. The present teachings are also applicable, without limitation, to duplexes, townhomes, multi-unit apartment buildings, hotels, retail stores, office buildings, industrial buildings, and more generally any living space or work space. Similarly, while the terms user, customer, installer, homeowner, occupant, guest, tenant, landlord, repair person, etc., may be used to refer to a person or persons acting in the context of some particular situations described herein, these references do not limit the scope of the present teachings with respect to the person or persons who are performing such actions. Thus, for example, the terms user, customer, purchaser, installer, subscriber, and homeowner may often refer to the same person in the case of a single-family residential dwelling, because the head of the household is often the person who makes the purchasing decision, buys the unit, and installs and configures the unit, as well as being one of the users of the unit. However, in other scenarios, such as a landlord-tenant environment, the customer may be the landlord with respect to purchasing the unit, the installer may be a local apartment supervisor, a first user may be the tenant, and a second user may again be the landlord with respect to remote control functionality. While the identity of the person performing the action may be germane to a particular advantage provided by one or more of the implementations, such an identity should not be construed in the descriptions that follow as necessarily limiting the scope of the present teachings to those particular individuals having those particular identities.

The depicted structure 150 includes a plurality of rooms 152, separated at least partly from each other via walls 154. The walls 154 may include interior walls or exterior walls. Each room may further include a floor 156 and a ceiling 158. Devices may be mounted on, integrated with and/or supported by a wall 154, floor 156, or ceiling 158.

In some implementations, the integrated devices of the smart-home environment 100 include intelligent, multi-sensing, network-connected devices that integrate seamlessly with each other in a smart-home network and/or with a central server or a cloud-computing system to provide a variety of useful smart-home functions. The smart-home environment 100 may include one or more intelligent, multi-sensing, network-connected thermostats 102 (hereinafter referred to as “smart thermostats 102”), one or more intelligent, network-connected, multi-sensing hazard detection units 104 (hereinafter referred to as “smart hazard detectors 104”), one or more intelligent, multi-sensing, network-connected entryway interface devices 106 and 120 (hereinafter referred to as “smart doorbells 106” and “smart door locks 120”), and one or more intelligent, multi-sensing, network-connected alarm systems 122 (hereinafter referred to as “smart alarm systems 122”). Although not depicted explicitly in FIG. 1, the smart-home environment 100 may also include other monitoring systems, such as baby monitoring systems, elderly monitoring systems, handicapped monitoring systems, and so forth.

In some implementations, the one or more smart thermostats 102 detect ambient climate characteristics (e.g., temperature and/or humidity) and control a HVAC system 103 accordingly. For example, a respective smart thermostat 102 includes an ambient temperature sensor.

The one or more smart hazard detectors 104 may include thermal radiation sensors directed at respective heat sources (e.g., a stove, oven, other appliances, a fireplace, etc.). For example, a smart hazard detector 104 in a kitchen 153 may include a thermal radiation sensor directed at a stove/oven 112. A thermal radiation sensor may determine the temperature of the respective heat source (or a portion thereof) at which it is directed and may provide corresponding blackbody radiation data as output.

The smart doorbell 106 and/or the smart door lock 120 may detect a person's approach to or departure from a location (e.g., an outer door), control doorbell/door locking functionality (e.g., receive user inputs from a portable electronic device 166-1 to actuate bolt of the smart door lock 120), announce a person's approach or departure via audio or visual devices, and/or control settings on a security system (e.g., to activate or deactivate the security system when occupants go and come). In some implementations, the smart doorbell 106 may include some or all of the components and features of the camera 118. In some implementations, the smart doorbell 106 includes a camera 118.

The smart alarm system 122 may detect the presence of an individual within close proximity (e.g., using built-in IR sensors), sound an alarm (e.g., through a built-in speaker, or by sending commands to one or more external speakers), and send notifications to entities or users within/outside of the smart-home network 100. In some implementations, the smart alarm system 122 also includes one or more input devices or sensors (e.g., keypad, biometric scanner, NFC transceiver, microphone) for verifying the identity of a user, and one or more output devices (e.g., display, speaker) for providing notifications. In some implementations, the smart alarm system 122 may also be set to an “armed” mode, such that detection of a trigger condition or event causes the alarm to be sounded unless a disarming action is performed.

In some implementations, the smart-home environment 100 may include one or more intelligent, multi-sensing, network-connected wall switches 108 (hereinafter referred to as “smart wall switches 108”), along with one or more intelligent, multi-sensing, network-connected wall plug interfaces 110 (hereinafter referred to as “smart wall plugs 110”). The smart wall switches 108 may detect ambient lighting conditions, detect room-occupancy states, and control a power and/or dim state of one or more lights. In some instances, smart wall switches 108 may also control a power state or speed of a fan, such as a ceiling fan. The smart wall plugs 110 may detect occupancy of a room or enclosure and control supply of power to one or more wall plugs (e.g., such that power is not supplied to the plug if nobody is at home).

In some implementations, the smart-home environment 100 of FIG. 1 may include a plurality of intelligent, multi-sensing, network-connected appliances 112 (hereinafter referred to as “smart appliances 112”), such as refrigerators, stoves, ovens, televisions, washers, dryers, lights, stereos, intercom systems, garage-door openers, floor fans, ceiling fans, wall air conditioners, pool heaters, irrigation systems, security systems, space heaters, window AC units, motorized duct vents, and so forth. In some implementations, when plugged in, an appliance may announce itself to the smart home network, such as by indicating what type of appliance it is, and it may automatically integrate with the controls of the smart home. Such communication by the appliance to the smart home may be facilitated by either a wired or wireless communication protocol. The smart home may also include a variety of non-communicating legacy appliances 140, such as older-model conventional washers/dryers, refrigerators, and/or the like, which may be controlled by smart wall plugs 110. The smart-home environment 100 may further include a variety of partially communicating legacy appliances 142, such as infrared (“IR”) controlled wall air conditioners or other IR-controlled devices, which may be controlled by IR signals provided by the smart hazard detectors 104, hand-held remote controls, key FOBs, or the smart wall switches 108.

In some implementations, the smart-home environment 100 may include one or more network-connected cameras 118 that are configured to provide video monitoring and security in the smart-home environment 100. The cameras 118 may be used to determine the occupancy of the structure 150 and/or particular rooms 152 in the structure 150, and thus may act as occupancy sensors. For example, video captured by the cameras 118 may be processed to identify the presence of an occupant in the structure 150 (e.g., in a particular room 152). Specific individuals may be identified based, for example, on their appearance (e.g., height, face) and/or movement (e.g., their walk/gait). Cameras 118 may additionally include one or more sensors (e.g., IR sensors, motion detectors), input devices (e.g., microphone for capturing audio), and output devices (e.g., speaker for outputting audio). In some implementations, the cameras 118 may each be configured to operate in a day mode and in a low-light mode (e.g., a night mode). In some implementations, the cameras 118 each include one or more IR illuminators for providing illumination while the camera is operating in the low-light mode. In some implementations, the cameras 118 include one or more outdoor cameras. In some implementations, the outdoor cameras include additional features and/or components such as weatherproofing and/or solar ray compensation.

The smart-home environment 100 may additionally or alternatively include one or more other occupancy sensors (e.g., the smart doorbell 106, smart door locks 120, touch screens, IR sensors, microphones, ambient light sensors, motion detectors, smart nightlights 170, etc.). In some implementations, the smart-home environment 100 may include radio-frequency identification (RFID) readers (e.g., in each room 152 or a portion thereof) that determine occupancy based on RFID tags located on or embedded in occupants. For example, RFID readers may be integrated into the smart hazard detectors 104, and RFID tags may be worn in users clothing for integrated in hand-held devices such as a smart phone.

The smart-home environment 100 may also include communication with devices outside of the physical home but within a proximate geographical range of the home. For example, the smart-home environment 100 may include a pool heater monitor 114 that communicates a current pool temperature to other devices within the smart-home environment 100 and/or receives commands for controlling the pool temperature. Similarly, the smart-home environment 100 may include an irrigation monitor 116 that communicates information regarding irrigation systems within the smart-home environment 100 and/or receives control information for controlling such irrigation systems.

By virtue of network connectivity, one or more of the smart home devices of FIG. 1 may further allow a user to interact with the device even if the user is not proximate to the device. For example, a user may communicate with a device using a computer (e.g., a desktop computer, laptop computer, or tablet) or other portable electronic device 166 (e.g., a mobile phone, such as a smart phone). A webpage or application may be configured to receive communications from the user and control the device based on the communications and/or to present information about the device's operation to the user. For example, the user may view a current set point temperature for a device (e.g., a stove) and adjust it using a computer. The user may be in the structure during this remote communication or outside the structure.

As discussed above, users may control smart devices in the smart-home environment 100 using a network-connected computer or portable electronic device 166. In some examples, some or all of the occupants (e.g., individuals who live in the home) may register their device 166 with the smart-home environment 100. Such registration may be made at a central server to authenticate the occupant and/or the device as being associated with the home and to give permission to the occupant to use the device to control the smart devices in the home. An occupant may use their registered device 166 to remotely control the smart devices of the home, such as when the occupant is at work or on vacation. The occupant may also use their registered device to control the smart devices when the occupant is actually located inside the home, such as when the occupant is sitting on a couch inside the home. It should be appreciated that instead of or in addition to registering devices 166, the smart-home environment 100 may make inferences about (1) which individuals live in the home and are therefore occupants, and (2) which devices 166 are associated with those individuals. As such, the smart-home environment may “learn” who is an occupant and permit the devices 166 associated with those individuals to control the smart devices of the home.

In some implementations, in addition to containing processing and sensing capabilities, devices 102, 104, 106, 108, 110, 112, 114, 116, 118, 120, and/or 122 (collectively referred to as “the smart devices” or “the smart-home devices”) are capable of data communications and information sharing with other smart devices, a central server or cloud-computing system, and/or other devices that are network-connected. Data communications may be carried out using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

In some implementations, the smart devices may serve as wireless or wired repeaters. In some implementations, a first one of the smart devices communicates with a second one of the smart devices via a wireless router. The smart devices may further communicate with each other via a connection (e.g., network interface 160) to a network, such as the Internet 162. Through the Internet 162, the smart devices may communicate with a server system 164 (also called a central server system and/or a cloud-computing system herein). The server system 164 may be associated with a manufacturer, support entity, or service provider associated with the smart device(s). In some implementations, a user is able to contact customer support using a smart device itself rather than needing to use other communication means, such as a telephone or Internet-connected computer. In some implementations, software updates are automatically sent from the server system 164 to smart devices (e.g., when available, when purchased, or at routine intervals).

In some implementations, the network interface 160 includes a conventional network device (e.g., a router), and the smart-home environment 100 of FIG. 1 includes a hub device 180 that is communicatively coupled to the network(s) 162 directly or via the network interface 160. The hub device 180 may be further communicatively coupled to one or more of the above intelligent, multi-sensing, network-connected devices (e.g., smart devices of the smart-home environment 100). Each of these smart devices optionally communicates with the hub device 180 using one or more radio communication networks available at least in the smart-home environment 100 (e.g., ZigBee, Z-Wave, Insteon, Bluetooth, Wi-Fi and other radio communication networks). In some implementations, the hub device 180 and devices coupled with/to the hub device can be controlled and/or interacted with via an application running on a smart phone, household controller, laptop, tablet computer, game console or similar electronic device. In some implementations, a user of such controller application can view status of the hub device or coupled smart devices, configure the hub device to interoperate with smart devices newly introduced to the home network, commission new smart devices, and adjust or view settings of connected smart devices, etc. In some implementations the hub device extends the capabilities of low-capability smart devices to match the capabilities of the highly capable smart devices of the same type, integrates functionality of multiple different device types—even across different communication protocols, and is configured to streamline adding of new devices and commissioning of the hub device. In some implementations, hub device 180 further comprises a local storage device for storing data related to, or output by, smart devices of smart-home environment 100. In some implementations, the data includes one or more of: video data output by a camera device, metadata output by a smart device, settings information for a smart device, usage logs for a smart device, and the like.

In some implementations, smart-home environment 100 includes a local storage device 190 for storing data related to, or output by, smart devices of smart-home environment 100. In some implementations, the data includes one or more of: video data output by a camera device (e.g., camera 118), metadata output by a smart device, settings information for a smart device, usage logs for a smart device, and the like. In some implementations, local storage device 190 is communicatively coupled to one or more smart devices via a smart home network. In some implementations, local storage device 190 is selectively coupled to one or more smart devices via a wired and/or wireless communication network. In some implementations, local storage device 190 is used to store video data when external network conditions are poor. For example, local storage device 190 is used when an encoding bitrate of camera 118 exceeds the available bandwidth of the external network (e.g., network(s) 162). In some implementations, local storage device 190 temporarily stores video data from one or more cameras (e.g., camera 118) prior to transferring the video data to a server system (e.g., server system 164).

In some implementations, the smart-home environment 100 includes service robots 168 that are configured to carry out, in an autonomous manner, any of a variety of household tasks.

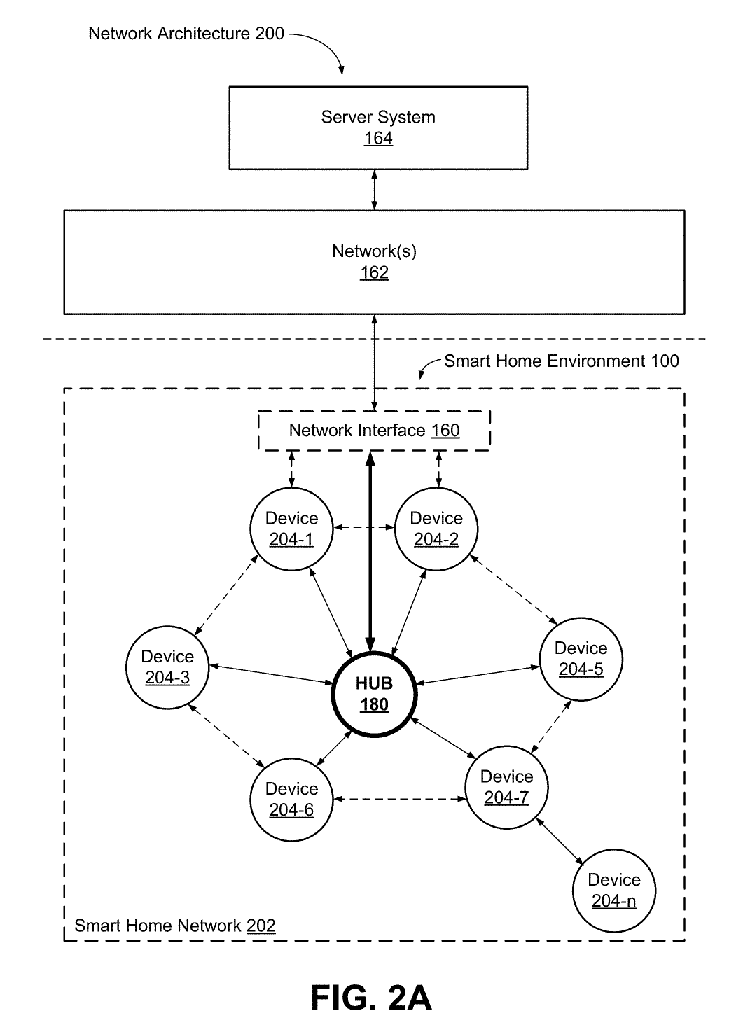

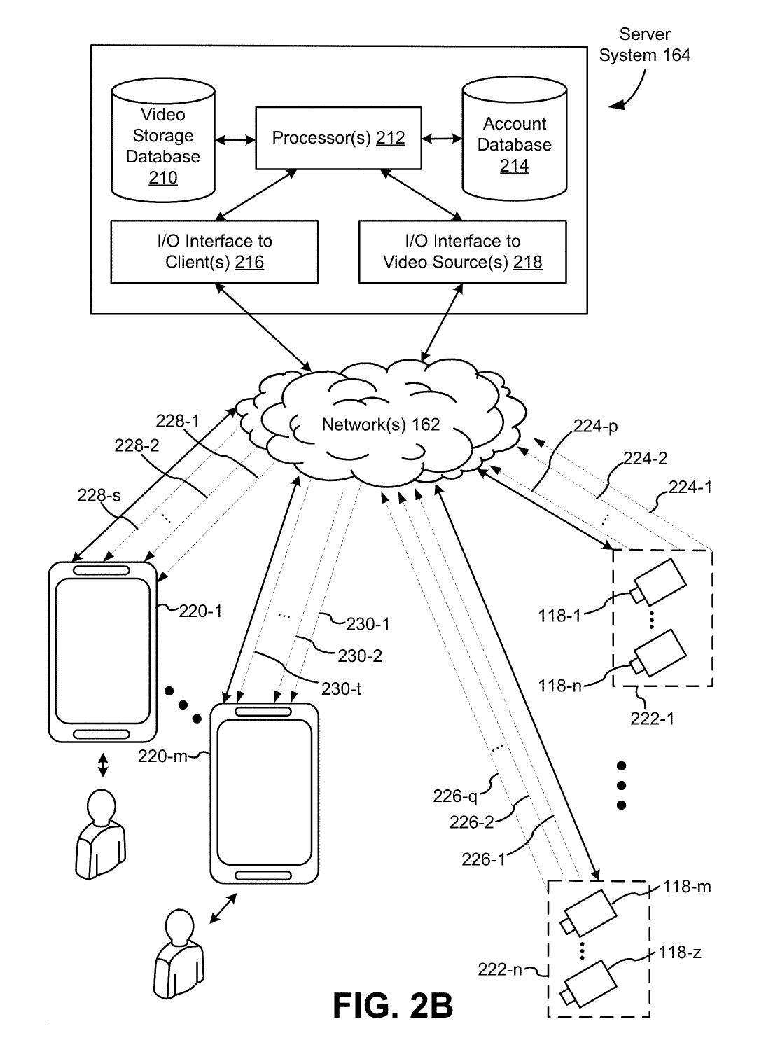

FIG. 2A illustrates a simplified block diagram of a representative network architecture 200 that includes a smart home network 202 in accordance with some implementations. In some implementations, the smart devices 204 in the smart-home environment 100 (e.g., devices 102, 104, 106, 108, 110, 112, 114, 116, 118, 120, and/or 122) combine with the hub device 180 to create a mesh network in smart home network 202. In some implementations, one or more smart devices 204 in the smart home network 202 operate as a smart home controller. Additionally and/or alternatively, hub device 180 operates as the smart home controller. In some implementations, a smart home controller has more computing power than other smart devices. In some implementations, a smart home controller processes inputs (e.g., from smart devices 204, electronic device 166, and/or server system 164) and sends commands (e.g., to smart devices 204 in the smart home network 202) to control operation of the smart-home environment 100. In some implementations, some of the smart devices 204 in the smart home network 202 (e.g., in the mesh network) are “spokesman” nodes (e.g., 204-1) and others are “low-powered” nodes (e.g., 204-9). Some of the smart devices in the smart-home environment 100 are battery powered, while others have a regular and reliable power source, such as by connecting to wiring (e.g., to 120V line voltage wires) behind the walls 154 of the smart-home environment. The smart devices that have a regular and reliable power source are referred to as “spokesman” nodes. These nodes are typically equipped with the capability of using a wireless protocol to facilitate bidirectional communication with a variety of other devices in the smart-home environment 100, as well as with the server system 164. In some implementations, one or more “spokesman” nodes operate as a smart home controller. On the other hand, the devices that are battery powered are the “low-power” nodes. These nodes tend to be smaller than spokesman nodes and typically only communicate using wireless protocols that require very little power, such as Zigbee, ZWave, 6LoWPAN, Thread, Bluetooth, etc.

In some implementations, some low-power nodes may be incapable of bidirectional communication. These low-power nodes may send messages, but they are unable to “listen.” Thus, other devices in the smart-home environment 100, such as the spokesman nodes, need not send information to these low-power nodes. In some implementations, some low-power nodes are capable of only a limited bidirectional communication. For example, other devices are able to communicate with the low-power nodes only during a certain time period.

In some implementations, the smart devices may serve as low-power and spokesman nodes to create a mesh network in the smart-home environment 100. In some implementations, individual low-power nodes in the smart-home environment may regularly send out messages regarding what they are sensing, and the other low-powered nodes in the smart-home environment—in addition to sending out their own messages—may forward these messages, thereby causing the messages to travel from node to node (i.e., device to device) throughout the smart home network 202. In some implementations, the spokesman nodes in the smart home network 202, which are able to communicate using a relatively high-power communication protocol, such as IEEE 802.11, are able to switch to a relatively low-power communication protocol, such as IEEE 802.15.4, to receive these messages, translate the messages to other communication protocols, and send the translated messages to other spokesman nodes and/or the server system 164 (using, e.g., the relatively high-power communication protocol). Thus, the low-powered nodes using low-power communication protocols are able to send and/or receive messages across the entire smart home network 202, as well as over the Internet 162 to the server system 164. In some implementations, the mesh network enables the server system 164 to regularly receive data from most or all of the smart devices in the home, make inferences based on the data, facilitate state synchronization across devices within and outside of the smart home network 202, and send commands to one or more of the smart devices to perform tasks in the smart-home environment.

The spokesman nodes and some of the low-powered nodes are capable of “listening.” Accordingly, users, other devices, and/or the server system 164 may communicate control commands to the low-powered nodes. For example, a user may use the electronic device 166 (e.g., a smart phone) to send commands over the Internet to the server system 164, which then relays the commands to one or more spokesman nodes in the smart home network 202. The spokesman nodes may use a low-power protocol to communicate the commands to the low-power nodes throughout the smart home network 202, as well as to other spokesman nodes that did not receive the commands directly from the server system 164.

In some implementations, a smart nightlight 170, which is an example of a smart device 204, is a low-power node. In addition to housing a light source, the smart nightlight 170 houses an occupancy sensor, such as an ultrasonic or passive IR sensor, and an ambient light sensor, such as a photo resistor or a single-pixel sensor that measures light in the room. In some implementations, the smart nightlight 170 is configured to activate the light source when its ambient light sensor detects that the room is dark and when its occupancy sensor detects that someone is in the room. In other implementations, the smart nightlight 170 is simply configured to activate the light source when its ambient light sensor detects that the room is dark. Further, in some implementations, the smart nightlight 170 includes a low-power wireless communication chip (e.g., a ZigBee chip) that regularly sends out messages regarding the occupancy of the room and the amount of light in the room, including instantaneous messages coincident with the occupancy sensor detecting the presence of a person in the room. As described above, these messages may be sent wirelessly (e.g., using the mesh network) from node to node (i.e., smart device to smart device) within the smart home network 202 as well as over the Internet 162 to the server system 164.

Other examples of low-power nodes include battery-operated versions of the smart hazard detectors 104. These smart hazard detectors 104 are often located in an area without access to constant and reliable power and may include any number and type of sensors, such as smoke/fire/heat sensors (e.g., thermal radiation sensors), carbon monoxide/dioxide sensors, occupancy/motion sensors, ambient light sensors, ambient temperature sensors, humidity sensors, and the like. Furthermore, smart hazard detectors 104 may send messages that correspond to each of the respective sensors to the other devices and/or the server system 164, such as by using the mesh network as described above.

Examples of spokesman nodes include smart doorbells 106, smart thermostats 102, smart wall switches 108, and smart wall plugs 110. These devices are often located near and connected to a reliable power source, and therefore may include more power-consuming components, such as one or more communication chips capable of bidirectional communication in a variety of protocols.

As explained above with reference to FIG. 1, in some implementations, the smart-home environment 100 of FIG. 1 includes a hub device 180 that is communicatively coupled to the network(s) 162 directly or via the network interface 160. The hub device 180 is further communicatively coupled to one or more of the smart devices using a radio communication network that is available at least in the smart-home environment 100. Communication protocols used by the radio communication network include, but are not limited to, ZigBee, Z-Wave, Insteon, EuOcean, Thread, OSIAN, Bluetooth Low Energy and the like. In some implementations, the hub device 180 not only converts the data received from each smart device to meet the data format requirements of the network interface 160 or the network(s) 162, but also converts information received from the network interface 160 or the network(s) 162 to meet the data format requirements of the respective communication protocol associated with a targeted smart device. In some implementations, in addition to data format conversion, the hub device 180 further processes the data received from the smart devices or information received from the network interface 160 or the network(s) 162 preliminary. For example, the hub device 180 can integrate inputs from multiple sensors/connected devices (including sensors/devices of the same and/or different types), perform higher level processing on those inputs—e.g., to assess the overall environment and coordinate operation among the different sensors/devices—and/or provide instructions to the different devices based on the collection of inputs and programmed processing. It is also noted that in some implementations, the network interface 160 and the hub device 180 are integrated to one network device. Functionality described herein is representative of particular implementations of smart devices, control application(s) running on representative electronic device(s) (such as a smart phone), hub device(s) 180, and server(s) coupled to hub device(s) via the Internet or other Wide Area Network (WAN). All or a portion of this functionality and associated operations can be performed by any elements of the described system—for example, all or a portion of the functionality described herein as being performed by an implementation of the hub device can be performed, in different system implementations, in whole or in part on the server, one or more connected smart devices and/or the control application, or different combinations thereof.

FIG. 2B illustrates a representative operating environment in which a server system 164 provides data processing for monitoring and facilitating review of events (e.g., motion, audio, security, etc.) in video streams captured by video cameras 118. As shown in FIG. 2B, the server system 164 receives video data from video sources 222 (including cameras 118) located at various physical locations (e.g., inside homes, restaurants, stores, streets, parking lots, and/or the smart-home environments 100 of FIG. 1). Each video source 222 may be bound to one or more reviewer accounts, and the server system 164 provides video monitoring data for the video source 222 to client devices 220 associated with the reviewer accounts. For example, the portable electronic device 166 is an example of the client device 220. In some implementations, the server system 164 is a video processing server that provides video processing services to video sources and client devices 220.

In some implementations, each of the video sources 222 includes one or more video cameras 118 that capture video and send the captured video to the server system 164 substantially in real-time. In some implementations, each of the video sources 222 includes a controller device (not shown) that serves as an intermediary between the one or more cameras 118 and the server system 164. The controller device receives the video data from the one or more cameras 118, optionally performs some preliminary processing on the video data, and sends the video data to the server system 164 on behalf of the one or more cameras 118 substantially in real-time. In some implementations, each camera has its own on-board processing capabilities to perform some preliminary processing on the captured video data before sending the processed video data (along with metadata obtained through the preliminary processing) to the controller device and/or the server system 164.

In accordance with some implementations, each of the client devices 220 includes a client-side module. The client-side module communicates with a server-side module executed on the server system 164 through the one or more networks 162. The client-side module provides client-side functionality for the event monitoring and review processing and communications with the server-side module. The server-side module provides server-side functionality for event monitoring and review processing for any number of client-side modules each residing on a respective client device 220. The server-side module also provides server-side functionality for video processing and camera control for any number of the video sources 222, including any number of control devices and the cameras 118.

In some implementations, the server system 164 includes one or more processors 212, a video storage database 210, an account database 214, an I/O interface to one or more client devices 216, and an I/O interface to one or more video sources 218. The I/O interface to one or more clients 216 facilitates the client-facing input and output processing. The account database 214 stores a plurality of profiles for reviewer accounts registered with the video processing server, where a respective user profile includes account credentials for a respective reviewer account, and one or more video sources linked to the respective reviewer account. The I/O interface to one or more video sources 218 facilitates communications with one or more video sources 222 (e.g., groups of one or more cameras 118 and associated controller devices). The video storage database 210 stores raw video data received from the video sources 222, as well as various types of metadata, such as motion events, event categories, event category models, event filters, and event masks, for use in data processing for event monitoring and review for each reviewer account.

Examples of a representative client device 220 include a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, a point-of-sale (POS) terminal, a vehicle-mounted computer, an eBook reader, or a combination of any two or more of these data processing devices or other data processing devices.

Examples of the one or more networks 162 include local area networks (LAN) and wide area networks (WAN) such as the Internet. The one or more networks 162 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the server system 164 may be implemented on one or more standalone data processing apparatuses or a distributed network of computers. In some implementations, the server system 164 also employs various virtual devices and/or services of third party service providers (e.g., third-party cloud service providers) to provide the underlying computing resources and/or infrastructure resources of the server system 164. In some implementations, the server system 164 includes, but is not limited to, a server computer, a handheld computer, a tablet computer, a laptop computer, a desktop computer, or a combination of any two or more of these data processing devices or other data processing devices.

The server-client environment shown in FIG. 2B includes both a client-side portion (e.g., the client-side module) and a server-side portion (e.g., the server-side module). The division of functionality between the client and server portions of operating environment can vary in different implementations. Similarly, the division of functionality between a video source 222 and the server system 164 can vary in different implementations. For example, in some implementations, the client-side module is a thin-client that provides only user-facing input and output processing functions, and delegates all other data processing functionality to a backend server (e.g., the server system 164). Similarly, in some implementations, a respective one of the video sources 222 is a simple video capturing device that continuously captures and streams video data to the server system 164 with limited or no local preliminary processing on the video data. Although many aspects of the present technology are described from the perspective of the server system 164, the corresponding actions performed by a client device 220 and/or the video sources 222 would be apparent to one of skill in the art. Similarly, some aspects of the present technology may be described from the perspective of a client device or a video source, and the corresponding actions performed by the video server would be apparent to one of skill in the art. Furthermore, some aspects of the present technology may be performed by the server system 164, a client device 220, and a video source 222 cooperatively.

In some implementations, a video source 222 (e.g., a camera 118) transmits one or more streams of video data to the server system 164. In some implementations, the one or more streams may include multiple streams, of respective resolutions and/or frame rates, of the raw video captured by the camera 118. In some implementations, the multiple streams may include a “primary” stream with a certain resolution and frame rate, corresponding to the raw video captured by the camera 118, and one or more additional streams. An additional stream may be the same video stream as the “primary” stream but at a different resolution and/or frame rate, or a stream that captures a portion of the “primary” stream (e.g., cropped to include a portion of the field of view or pixels of the primary stream) at the same or different resolution and/or frame rate as the “primary” stream.

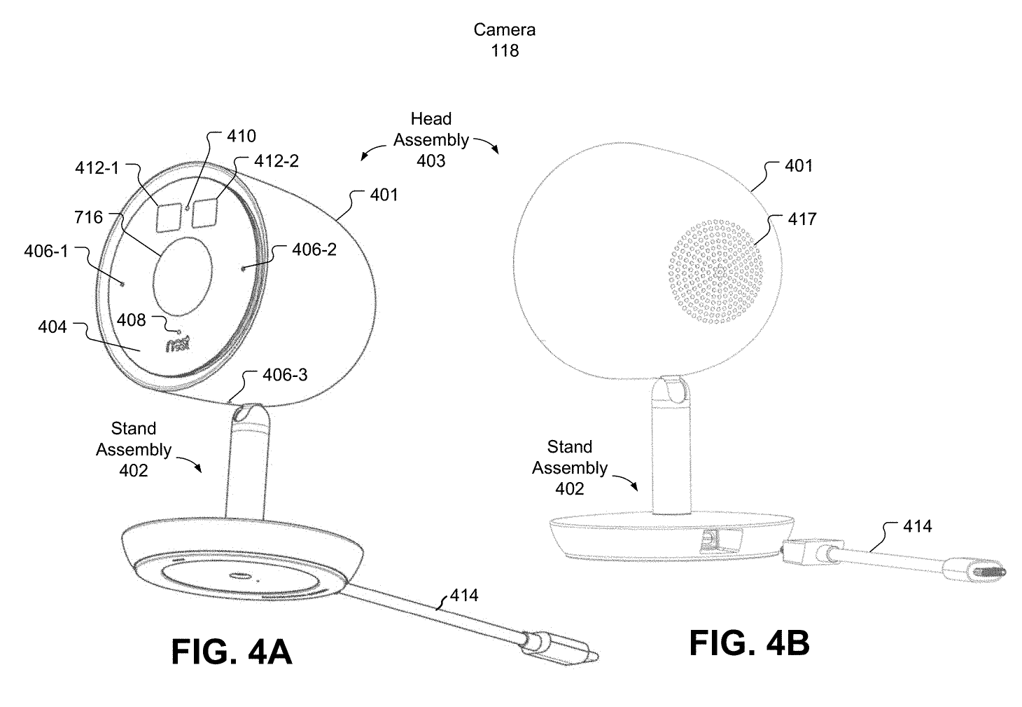

In some implementations, one or more of the streams are sent from the video source 222 directly to a client device 220 (e.g., without being routed to, or processed by, the server system 164). In some implementations, one or more of the streams is stored at the camera 118 (e.g., in memory 406, FIG. 4) and/or a local storage device (e.g., a dedicated recording device), such as a digital video recorder (DVR). For example, in accordance with some implementations, the camera 118 stores the most recent 24 hours of video footage recorded by the camera. In some implementations, portions of the one or more streams are stored at the camera 118 and/or the local storage device (e.g., portions corresponding to particular events or times of interest).

In some implementations, the server system 164 transmits one or more streams of video data to a client device 220 to facilitate event monitoring by a user. In some implementations, the one or more streams may include multiple streams, of respective resolutions and/or frame rates, of the same video feed. In some implementations, the multiple streams may include a “primary” stream with a certain resolution and frame rate, corresponding to the video feed, and one or more additional streams. An additional stream may be the same video stream as the “primary” stream but at a different resolution and/or frame rate, or a stream that shows a portion of the “primary” stream (e.g., cropped to include portion of the field of view or pixels of the primary stream) at the same or different resolution and/or frame rate as the “primary” stream, as described in greater detail in U.S. patent application Ser. No. 15/594,518, which is incorporated herein by reference.

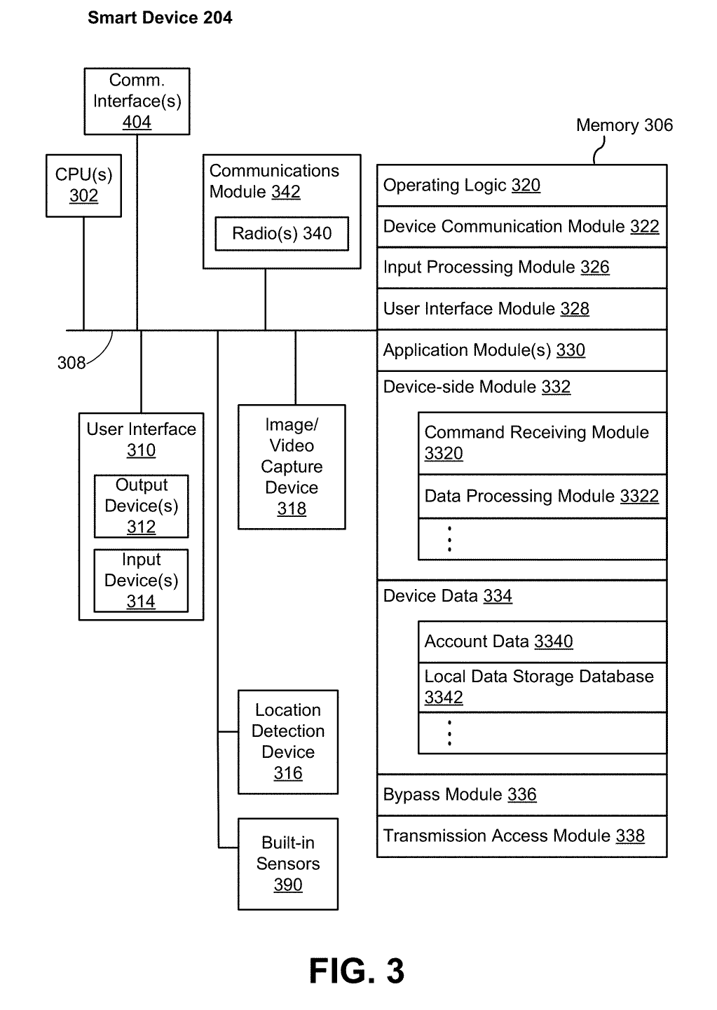

FIG. 3 illustrates a block diagram of a representative smart device 204 in accordance with some implementations. In some implementations, the smart device 204 (e.g., any devices of a smart-home environment 100, FIG. 1) includes one or more processing units (e.g., CPUs, ASICs, FPGAs, microprocessors, and the like) 302, one or more communication interfaces 304, memory 306, communications module 342 with radios 340, and one or more communication buses 308 for interconnecting these components (sometimes called a chipset). In some implementations, the user interface 310 includes one or more output devices 312 that enable presentation of media content, including one or more speakers and/or one or more visual displays. In some implementations, the user interface 310 also includes one or more input devices 314, including user interface components that facilitate user input such as a keyboard, a mouse, a voice-command input unit or microphone, a touch screen display, a touch-sensitive input pad, a gesture capturing camera, or other input buttons or controls. Furthermore, some smart devices 204 use a microphone and voice recognition or a camera and gesture recognition to supplement or replace the keyboard. In some implementations, the smart device 204 includes one or more image/video capture devices 318 (e.g., cameras, video cameras, scanners, photo sensor units). The built-in sensors 390 may include, for example, one or more thermal radiation sensors, ambient temperature sensors, humidity sensors, IR sensors, occupancy sensors (e.g., using RFID sensors), ambient light sensors, motion detectors, accelerometers, and/or gyroscopes.

The radios 340 enable one or more radio communication networks in the smart-home environments, and allow a smart device 204 to communicate with other devices. In some implementations, the radios 340 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.) custom or standard wired protocols (e.g., Ethernet, HomePlug, etc.), and/or any other suitable communication protocol, including communication protocols not yet developed as of the filing date of this document.

The communication interfaces 304 include, for example, hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

The memory 306 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 306, or alternatively the non-volatile memory within the memory 306, includes a non-transitory computer readable storage medium. In some implementations, the memory 306, or the non-transitory computer readable storage medium of the memory 306, stores the following programs, modules, and data structures, or a subset or superset thereof: operating logic 320 including procedures for handling various basic system services and for performing hardware dependent tasks; a device communication module 322 for connecting to and communicating with other network devices (e.g., network interface 160, such as a router that provides Internet connectivity, networked storage devices, network routing devices, server system 164, etc.) connected to one or more networks 162 via one or more communication interfaces 304 (wired or wireless); an input processing module 326 for detecting one or more user inputs or interactions from the one or more input devices 314 and interpreting the detected inputs or interactions; a user interface module 328 for providing and displaying a user interface in which settings, captured data, and/or other data for one or more devices (e.g., the smart device 204, and/or other devices in smart-home environment 100) can be configured and/or viewed; one or more applications 330 for execution by the smart device (e.g., games, social network applications, smart home applications, and/or other web or non-web based applications) for controlling devices (e.g., executing commands, sending commands, and/or configuring settings of the smart device 204 and/or other client/electronic devices), and for reviewing data captured by devices (e.g., device status and settings, captured data, or other information regarding the smart device 204 and/or other client/electronic devices); a device-side module 332, which provides device-side functionalities for device control, data processing and data review, including but not limited to: a command receiving module 3320 for receiving, forwarding, and/or executing instructions and control commands (e.g., from a client device 220, from a server system 164, from user inputs detected on the user interface 310, etc.) for operating the smart device 204; a data processing module 3322 for processing data captured or received by one or more inputs (e.g., input devices 314, image/video capture devices 318, location detection device 316), sensors (e.g., built-in sensors 390), interfaces (e.g., communication interfaces 304, radios 340), and/or other components of the smart device 204, and for preparing and sending processed data to a device for review (e.g., client devices 220 for review by a user); device data 334 storing data associated with devices (e.g., the smart device 204), including, but is not limited to: account data 3340 storing information related to user accounts loaded on the smart device 204, wherein such information includes cached login credentials, smart device identifiers (e.g., MAC addresses and UUIDs), user interface settings, display preferences, authentication tokens and tags, password keys, etc.; local data storage database 3342 for selectively storing raw or processed data associated with the smart device 204 (e.g., video surveillance footage captured by a camera 118); a bypass module 336 for detecting whether radio(s) 340 are transmitting signals via respective antennas coupled to the radio(s) 340 and to accordingly couple radio(s) 340 to their respective antennas either via a bypass line or an amplifier (e.g., a low noise amplifier); and a transmission access module 338 for granting or denying transmission access to one or more radio(s) 340 (e.g., based on detected control signals and transmission requests).

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise rearranged in various implementations. In some implementations, the memory 306, optionally, stores a subset of the modules and data structures identified above. Furthermore, the memory 306, optionally, stores additional modules and data structures not described above.

FIGS. 4A-4B are perspective views of a representative camera assembly in accordance with some implementations. FIG. 4A shows a first perspective view of a representative camera 118. As shown in FIG. 4A, the camera 118 includes a head assembly 403, a stand assembly 402, and a cable 414 (e.g., for powering the camera 118 and/or transferring data between the camera 118 and a second electronic device.). The head assembly 403 includes a cover element 404 and a casing 401 (also sometimes called a housing). In accordance with some implementations, the cover element 404 has IR transparent portions 412 for IR illuminators, visible and IR transparent portion 416 for an image sensor, and semi-transparent portions 410 (corresponding to an ambient light sensor) and 408 (corresponding to a status LED). In accordance with some implementations, the cover element 404 also includes apertures 406 for microphones. In accordance with some implementations, the casing 401 includes an aperture 406-3 for a microphone.

In some implementations, the casing 401 has two or more layers. In some implementations, the inner layer is composed of a thermally conductive resin. In some implementations, the outer layer is a structural jacket configured to protect the camera 118 from environmental conditions such as moisture or electromagnetic charge (e.g., static electricity). In some implementations, the structural jacket is configured to protect the camera 118 from impacts, such as from a collision with another object or the ground.

FIG. 4B shows a back view of the camera 118. As shown in FIG. 4B the cable 414 is detachable from the stand assembly 402. For example, a user may store the cable 414 separately from the camera 118 when desired. In accordance with some implementations, the casing 401 includes a plurality of apertures 417 for a speaker.

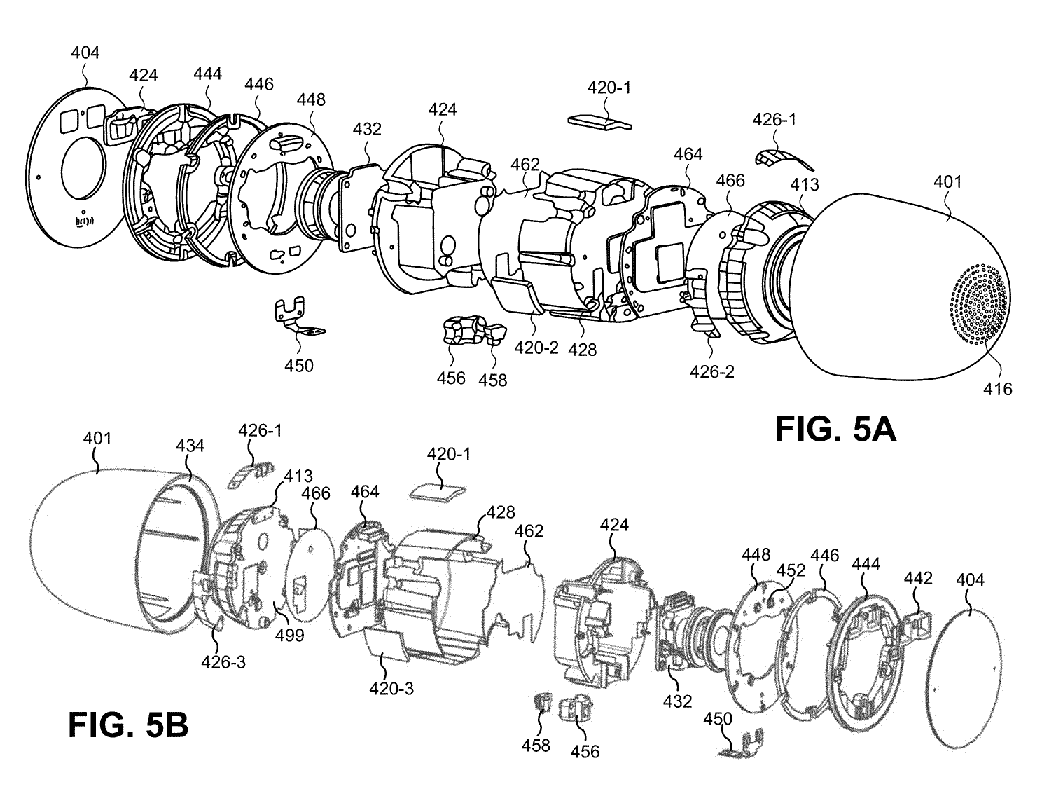

FIGS. 5A-5B are expanded component views of a representative camera assembly in accordance with some implementations. The camera 118 includes a cover element 404, an image sensor assembly 432, a speaker assembly 413, and a main circuit board 464. In some implementations, the speaker assembly 413 includes a speaker and a heat sink. In some implementations, the heat sink is configured to dissipate heat generated at the main board 464.

In some implementations, the speaker assembly 413 acts as a heat sink for the camera's system-on-a-chip (SoC). In some implementations, the SoC is thermally coupled to the speaker assembly 413 with a thermal pad. In some implementations, the thermal pad's area is smaller than the speaker assembly's bottom surface 499. For optimal heat dissipation it is beneficial to spread the heat from the thermal pad over the entire bottom surface of the speaker assembly. In some implementations, a thermally graphite sheet (e.g., thermally conductive sheet 466) is used to achieve this spreading since graphite has very high in-plane thermal conductivity.

In some implementations, the camera 118 is a video streaming device with powerful computing capability embedded in the device. Therefore, in some instances, it will consume a lot of power and will also generate a lot of heat. In order to prevent the chipset and other components from being damaged by the heat, a thermal relief solution includes directing the heat from the CPU (e.g., a CPU of the SoC) to the speaker assembly 413. In some implementations, the speaker assembly 413 is composed of a thermally conductive plastic that is structurally suitable and has good heat spreading properties. In some implementations, a thermal pad on top of the shield can is used to direct the heat to the speaker assembly. To further distribute the heat onto the speaker, in some implementations, a graphite sheet is placed on the bottom surface of the speaker assembly. In some implementations, the size of the graphite sheet is maximized to achieve the best thermal relief function.

The camera 118 includes the cover element 404 having the IR transparent portions 412 for IR illuminators, the apertures 406 for microphones, the semi-transparent portion 408 corresponding to a status LED, and the semi-transparent portion 410 corresponding to an ambient light sensor. The camera 118 also includes a plurality of heat pads 420 for dissipating heat from the main board 464 and a thermal receiver structure 428 (e.g., having a shape like that of a fryer pot, hereinafter referred to as “fryer pot 428”) to the casing 401, a plurality of antennas 426 for wirelessly communicating with other electronic devices, a thermal mount structure 424 (e.g., having a shape like that of a fryer basket, hereinafter referred to as “fryer basket 424”) for dissipating and transferring heat from the image sensor assembly 432 to the cover element 404, and pads for thermally isolating the fryer basket 424 from the fryer pot 428.

In some implementations, the heat pads 420 are adapted to transfer heat from the fryer pot 428 to the casing 401. In some implementations, the heat pads 420 are adapted to thermally couple an inner layer of the casing 401 and the fryer pot 428. In some implementations, the heat pads are composed of a plastic. In some implementations, the heat pads are adapted to thermally de-couple the fryer basket 424 from the fryer pot 428. In some implementations, the fryer basket 424 is composed of magnesium. In some implementations, the fryer basket 424 is adapted to dissipate heat from the image sensor assembly 432. In some implementations, the fryer basket 424 is adapted to provide structural support to the camera 118. In some implementations, the fryer basket 424 is adapted to protect the image sensor assembly 432 from environmental forces such as moisture and/or impact from objects and/or the ground.

In some implementations, the antennas 426 are configured to operate concurrently using two distinct frequencies. In some implementations, the antennas 426 are configured to operate concurrently using two distinct communication protocols. In some implementations, one or more of the antennas 426 is configured for broadband communications (e.g., Wi-Fi) and/or point-to-point communications (e.g., Bluetooth). In some implementations, one or more of the antennas 426 is configured for mesh networking communications (e.g., ZWave). In some implementations, a first antenna 426 (e.g., antenna 426-1) is configured for 2.4 GHz Wi-Fi communication and a second antenna 426 (e.g., antenna 426-2) is configured for 5 GHz Wi-Fi communication. In some implementations, a first antenna 426 (e.g., antenna 426-1) is configured for 2.4 GHz Wi-Fi communication and point-to-point communication, a second antenna 426 (e.g., antenna 426-2) is configured for 5 GHz Wi-Fi communication and point-to-point communication, and a third antenna 426 (e.g., antenna 426-3) is configured for mesh networking communication. In some implementations, two or more of the antennas 426 are configured to transmit and/or receive data concurrently with others of the antennas 426. MIMO (multi input multi output) provides the benefit of greater throughput and better range for the wireless communication.

One of the parameters in the antenna system is the isolation between two antennas. Better isolation can ensure the data transmitted through two antennas are uncorrelated which is the key to the MIMO system. One way to achieve good isolation is to have large antenna separations. However, in modern consumer electronics the space left for antennas is very tight so having enough spacing between antennas is infeasible. While isolation is important, the antenna efficiency cannot be sacrificed. Isolation is directly related to how much energy is coupled from one antenna to another. The Friis equation defines the power received by another antenna as inversely proportional to (1/R)², where R is the distance between two antennas. So increasing antenna spacing is one effective way to achieve good isolation. Another means to achieve isolation is through use of a decoupling network. For example, an artificial coupling channel is generated in additional to its original coupling channel (e.g., which is through air). By properly managing the two coupling channels, the good isolation can be achieved.

In some implementations, the antennas 426 include at least one dual-band Inverted-F Antenna (IFA). In some implementations, the antennas are made by FPC, LDS, Stamping, or other state of art antenna manufacturing technology. In some implementations, the fryer pot 428 is a system ground for one or more of the antennas 426. In some implementations, the size of the antenna is about quarter-wavelength at 2.4 GHz. In some implementations, each antenna includes a radiating element, a feed line, and a ground stub. The ground stub presents an inductance to compensate for capacitance generated between the radiating element and the fryer pot 428. In some implementations, at least one of the antennas 426 includes a second ground stub. The second ground stub is adapted to match the antenna to both 2.4 GHz and 5 GHz. In some implementations, the antenna feed is the feeding point for the 2.4 GHz and 5 GHz WiFi signal. In some implementations, the feed point is connected to the output of a WiFi chip. In some implementations, the antennas 426 include two identical IFA antennas. Both antennas are attached to the speaker assembly 413.

In some implementations, at least one of the antennas 426 includes a second type of antenna having first radiating element, a second radiating element, a first ground stub, and second ground stub. In some implementations, the size of the first radiating element is around quarter wavelength of 5 GHz. In some implementations, the resonance frequency at 2.4 GHz is determined by: (i) the size of the second radiating element, (ii) the position of the first ground stub, and (iii) the position of the second ground stub. In some implementations, the first ground stub is placed at a pistol end of the second radiating element. In some implementations, the second ground stub is between the first radiating element and the first ground stub. In some implementations, the position where second ground stub is attached to the second radiating element is adjusted to tune to the resonant frequency at 2.4 GHz. In some implementations, the first ground stub not only acts as part of the antenna, but also a shielding element that can reduce coupling coming from the left-handed side of the first ground stub. In some implementations, the second ground stub is also a shielding element to further reduce the coupling coming from the left handed side of the antenna. In some implementations, the second type of antenna includes more than 2 ground stubs. By using more ground stubs the antenna's physical size can be enlarged while maintaining the same resonant frequency (e.g., 2.4 GHz). In some implementations, the first and second ground stubs are on the right-handed side of the first radiating element to reduce coupling coming from the right-handed side. In some implementations, the antennas 426 include one or more antennas of a first type (e.g., IFAs) and one or more antennas of the second type.

By using a set of antennas including both a first type of antenna (e.g., an IFA) and the second type of antenna, two antennas can be positioned in a tight space while maintaining both good efficiency and good isolation between them. This enables the camera 118 to be compact without sacrificing the quality of wireless connectivity. In some implementations, both types of antennas are manufactured by conventional FPC technology with low cost. Unlike an antenna system relying on a decoupling system to achieve a similar isolation level, the IFA and second type antennas can be optimized and/or tuned independently.

The camera 118 may include the cover element 404, casing 401 with speaker holes 417, the image sensor assembly 432, and a speaker assembly 413. In some implementations, as shown, the speaker holes 417 extend directly outward from the speaker, which results in holes with an elliptical outer surface. In some implementations, the speaker holes 417 are parallel to one another. In some implementations, the speaker holes 417 extend outward at an angle consistent with the rear surface of the casing 401 such that the holes have a circular, rather than elliptical, outer surface (not shown). The camera 118 also includes a light guide 434 for directing light from a light assembly out the face of the camera 118.

The camera 118 includes an infrared (IR) reflector 442, a light diffuser 444, a light guide 446, a light ring 448, a microphone assembly 450, the image sensor assembly 432, the fryer basket 424, stand coupling elements 456 and 458, the fryer pot 428, a thermal insulator 462 adapted to thermally isolate the fryer pot 428 from the fryer basket 424, the main board 464, the thermally conductive sheet 466, the antennas 426, the speaker assembly 413, and the casing 401. In accordance with some implementations, the casing 401 has a lip 434 for reflecting and directing light from the light diffuser 444 outward from the face of the camera 118.

In some implementations, the cover element 404 comprises a chemically-strengthened glass. In some implementations, the cover element 404 comprises a soda-lime glass.

In some implementations, the image sensor assembly 432 includes a circuit board (e.g., a PCB board), an IR cut filter, a lens holder, and an image sensor. In some implementations, the image sensor comprises a 4 k image sensor. In some implementations, the image sensor comprises a 12 megapixel sensor. In some implementations, the image sensor comprises a wide-angle lens.

In some implementations, the thermally conductive sheet 466 is adapted to dissipate heat generated by the main board 464 and/or transfer heat from the main board 464 to the speaker assembly 413 for subsequent dissipation outside of the camera via the rear portion of the casing 401. In some implementations, the conductive sheet 466 is a graphite sheet. When a graphite sheet is placed near the antenna system with multiple antennas, it can create a coupling medium between antennas. The increased coupling caused by the graphite can decrease the isolation between two antennas, thus degrading antenna efficiency or causing permanent damage to the chipset.

In some implementations, the antennas 426 are configured to enable the camera 118 to wirelessly communication with one or more other electronic devices, such as a hub device 180, a smart device 204, and/or a server system 164.

In some implementations, the fryer pot 428 is composed of magnesium. In some implementations, the fryer pot 428 is adapted to provide structural support to the camera 118.

In some implementations, the fryer pot 428, the main board 464, the conductive sheet 466, the speaker assembly 413, and the antennas 426 comprise a rear sub-assembly. Thermally de-coupling the fryer basket 424 from the fryer pot 428 prevents heat generated by the main board 464 from interfering with the image sensor assembly 432. In accordance with some implementations, heat generated by the front of the main board 464 is transferred to the fryer pot 428 to the heat pads 420 and dissipated outside of the camera via the casing 401 (e.g., the sides of the casing). In accordance with some implementations, heat generated by the back of the main board 464 is transferred to the thermally conductive sheet 466 to the speaker assembly 413 and dissipated outside of the camera via the back portion of the casing 401.

In some implementations, the rear sub-assembly is affixed to the casing 401 via one or more fasteners (e.g., via 2-3 screws). In some implementations, the cover element 404, the infrared reflector 442, the light diffuser 444, the light guide 446, the light ring 448, and the image sensor assembly 432 comprise a front sub-assembly. In some implementations, the front sub-assembly is affixed to the casing 401 via one or more fasteners (e.g., 2-3 screws). In some implementations, the front sub-assembly is affixed to the rear sub-assembly via one or more fasteners.

In some implementations, the fryer basket 424 is adapted to dissipate heat generated by the image sensor assembly 432 and/or the light ring 448. In some implementations, the fryer basket 424 includes one or more forward-facing microphones. In some implementations, the downward-facing microphone 450 is operated in conjunction with the microphones on the fryer basket 424 to determine directionality and/or location of incoming sounds.

In some implementations, the IR reflector 442 is coated with an IR and/or visible light reflective coating. In some implementations, the IR reflector 442 is adapted to direct light from the IR illuminators 452 to a scene corresponding to a field of view of the image sensor assembly 432.

In some implementations, the light ring 448 comprises a plurality of visible light illuminators (e.g., RGB LEDs), a plurality of IR illuminators 452, and circuitry for powering and/or operating the visible light and/or IR illuminators. In some implementations, the light guide 446 is adapted to direct light from the visible light illuminators out the face of the camera 118. In some implementations, the light guide 446 is adapted to prevent light from the visible light illuminators from entering the image sensor assembly 432. In some implementations, the light guide 446 is adapted to spread the light from the visible light illuminators in a substantially even manner. In some implementations, the light guide 446 is composed of a clear material. In some implementations, the light guide 446 is composed of a poly-carbonite material. In some implementations, the light guide 446 has a plurality of dimples to refract the light from the illuminators and prevent the light from entering the image sensor assembly 432. In some implementations, the light guide 446 is adapted to provide more uniform color and light output to a user from the illuminators. In some implementations, the light guide 446 includes a plurality of segments, each segment corresponding to a visible light illuminator. In some implementations, the light guide 446 includes one or more light absorbing elements (e.g., black stickers) arranged between each segment to prevent light leakage from one illuminator segment to another illuminator segment.

In some implementations, the light diffuser 444 includes two or more sections (e.g., an inner section and an outer section). In some implementations, the light diffuser 444 is adapted to diffuse the light from the visible light illuminators. In some implementations, the light diffuser 444 is adapted to direct the light from the illuminators toward the lip 434 of the casing 401. In some implementations, the light ring 448 (and corresponding elements such as the light guide 446 and/or light diffuser 444) causes a circular colored (or white) light to be emitted from the front of the camera 118. In some implementations the components and corresponding light are circular and arranged around the periphery of the front of the camera 118. They may encircle all or substantially all elements of the camera 118, such as the image sensor assembly 432, the IR illuminators 452, the ambient light sensor 451, a status LED, and the microphone apertures 406. In other implementations, they are arranged not around the periphery but rather at an inner diameter, e.g., around only the image sensor assembly 432. In yet other implementations, they do not surround any front-facing element of the camera 118.

In some implementations, they are arranged in a non-circular shape, such as a square, oval, or polygonal shape. In some implementations, they are not arranged on the front of the device but rather a different surface of the device, such as the bottom, top, sides, or back. In some implementations, multiple such light rings and components are arranged onto the same or different surfaces of the camera 118.

The light ring 448 (and corresponding elements) may operate to indicate a status of the camera 118, another device within or outside of the smart home environment 100 (e.g., another device communicatively coupled either directly or indirectly to the camera 118), and/or the entire connected smart home environment 100 (e.g., system status). The light ring 448 (and corresponding elements) may cause different colors and/or animations to be displayed to a user that indicate such different statuses.

For example, in the context of communicating camera 118 status, when the camera 118 is booting for the first time or after a factor reset, the ring may pulse blue once at a slow speed. When the camera 118 is ready to begin setup, the ring may breathe blue continually. When the camera 118 is connected to a remote cloud service and provisioning is complete (i.e., the camera is connected to a user's network and account), the ring may pulse green once. When there is a service connection and/or provisioning failure, the ring may blink yellow at a fast speed. When the camera 118 is being operated to facilitate two-way talk (i.e., audio is captured from the audio and communicated to a remote device for output by that remote device simultaneously with audio being captured from the remote device and communicated to the camera 118 for output by the camera 118), the ring may breathe blue continuously at a fast speed. When the camera 118 is counting down final seconds before a factory reset, the ring may close on itself at a rate equal to the time until reset (e.g., five seconds). When the camera 118 has been factory and while the setting are being erased the ring may rotate blue continuously. When there is insufficient power for the camera 118 the ring may blink red continuously at a slow speed. The visual indications are optionally communicated simultaneously, concurrently, or separately from audio indications that signal to the user a same or supplemental message. For example, when the camera 118 is connected to a remote cloud service and provisioning is complete (i.e., the camera is connected to a user's network and account), the ring may pulse green once and output an audio message that “remote cloud service and provisioning is complete.”

Additionally or alternatively, the camera 118 may communicate the status of another device in communication with the camera 118. For example, when a hazard detector 104 detects smoke or fire sufficient to alarm, the camera 118 may output a light ring that pulses red continuously at a fast speed. When a hazard detector 104 detects smoke or fire sufficient to warn a user but not alarm, the camera 118 may output a light ring that pulses yellow a number of times. When a visitor engages a smart doorbell 106 the camera 118 may output a light ring depending on the engagement; e.g., if the smart doorbell 106 detects motion, the camera 118 may output a yellow light ring, if a user presses a call button on the smart doorbell 106, the camera 118 may output a green light ring. In some implementations, the camera 118 may be communicatively coupled to the doorbell 106 to enable audio communication therebetween, in which case an animation and/or color of the light ring may change depending on whether the user is speaking to the visitor or not through the camera 118 or another device.

Additionally or alternatively, the camera 118 may communicate the cumulative status of a number of network-connected devices in the smart home environment 100. For example, a smart alarm system 122 may include proximity sensors, window break sensors, door movement detectors, etc. A whole home state may be determined based on the status of such a plurality of sensors/detectors. For example, the whole home state may be secured (indicating the premises is secured and ready to alarm), alarming (indicating a determination that a break-in or emergency condition exists), or somewhere in between such as pre-alarming (indicating a determination that a break-in or emergency condition may exist soon or unless some condition is satisfied). For example, the camera 118 light ring may pulse red continuously when the whole home state is alarming, may pulse yellow when the whole home state is pre-alarming, and/or may be solid green when the whole home state is secured. In some implementations, such visual indications may be communicated simultaneously (or separately from) with audio indications that signal to the user the same or supplemental message. For example, when the whole home state is alarming, the ring may pulse red once and output an audio message that indicates the alarm “alarm”. In some implementations, the audio message may provide supplemental information that cannot be conveyed via the light ring. For example, when the whole home state is alarming due to a basement window being broken, the audio message may be “alarm—your basement window has been broken.” For another example, when a pre-alarm amount of smoke has been detected by a hazard detector 104 located in the kitchen, the audio message may be “warning—smoke is detected in your kitchen.”

In some implementations, the camera 118 may also or alternatively have a status LED. Such a status LED may be used to less-instructively communicate camera 118, other device, or multiple device status information. For example, the status light may be solid green during initial setup, solid green when streaming video and/or audio data normally, breathing green when someone is watching remotely, solid green when someone is watching remotely and speaking through the camera 118, and off when the camera 118 is turned off or the status LED is disabled. It should be appreciated that the status LED may be displayed simultaneously with the light ring. For example, the status LED may be solid green during setup while the light ring breathes blue, until the end of setup when the device is connected to the service and provisioning is complete whereby the status LED may continue to be solid green while the light ring switches to a single pulse green.

### Temperature-Based Subject Monitoring

The camera 118 described above in detail has many different uses in the smart-home environment. In the context of a security system, the camera 118 can detect human presence and/or motion, and can provide a real-time video feed of the monitored area to a user's smart phone or other mobile computing device. In a hazard-detection scenario, the camera 118 can provide a real-time video feed of a situation in which a hazard might exist. For example, if smoke is detected within the smart-home environment, the camera 118 can provide a view to show areas of the environment that may be affected by the fire or smoke. The camera 118 can be used to determine whether the alarm is a false alarm or an alarm situation to which a response may be required. A single camera 118 or set of cameras can be installed in a smart-home environment, and they can be put to many different simultaneous uses. For example, a single camera can be part of a home security system and part of a hazard detection system at the same time. One of the many uses to which the camera 118 can be simultaneously employed is that of monitoring any infant or other subject within the smart-home environment.

Many parents find comfort in being able to monitor their sleeping infant in real time. Video monitoring systems are available that provide a live video feed of an infant in their sleep environment. These live video feeds are traditionally sent through an RF frequency communication system to a dedicated video monitor or console that can be plugged in at different locations in the user's home. However, these traditional infant monitoring systems that employ live video feeds suffer from a number of drawbacks. First, these traditional systems typically employ a low resolution camera. The resultant video feed is typically grainy, and it is impossible to view details of the infant. Second, these cameras are typically unable to provide any additional information other than the live video feed itself. The live video feed provides very little information on the health and/or safety condition of the infant. Moreover, because there is no interactivity in these traditional video feeds, these baby monitors do not provide any meaningful emotional connection between the user and the infant.

In order to solve these and other technical problems, the embodiments described herein use the camera 118 with its high-resolution live video feed to perform additional processing on the live video feed itself. Specifically, the lens of the camera 118 may include a thermal imager that provides a real-time video feed of thermal images of the subject instead of or in addition to the live video feed of visible-light images of the monitored subject. The thermal images may be used to establish a baseline thermal signature for the subject, such as a baseline thermal facial pattern, as well as a baseline temperature estimate. Current thermal images of the subject may be compared to the baseline images/patterns to diagnose certain health conditions and/or sleep conditions for the subject. For example, a baseline temperature reading can be compared to a current temperature estimate to determine whether the subject is suffering from an elevated temperature or fever condition. In another example, current thermal patterns in the face of the subject can be compared to known patterns to determine whether the subject is too cold, too hot, teething, and so forth. The live video stream along with the thermal images from the thermal video stream can be transmitted to a user's computing device. The user's computing device can display the live/thermal video streams in real time and/or provide indications regarding the thermal analysis of the subject. For example, the computing device can notify the user that the temperature of the subject appears to be elevated. The mobile device can also provide links and/or additional information that can be used to treat or further diagnose any physical conditions that are detected by the thermal analysis.

Throughout this disclosure, the monitoring system may use the monitoring of an infant as an example. However, other embodiments are not limited to an infant in a sleep environment. Some embodiments may monitor other types of subjects, such as the elderly, the physically disabled, and/or other human subjects. These subjects may also be monitored in any environment aside from a sleep environment. For example, a subject could be monitored in a wheelchair, in a swimming pool, in a bed, in a recliner, on a couch, and/or any other environment. Although the camera 118 described above is also used as an example, other embodiments may use different home video cameras that are configured to capture a live and/or thermal video feed of the monitored subject.

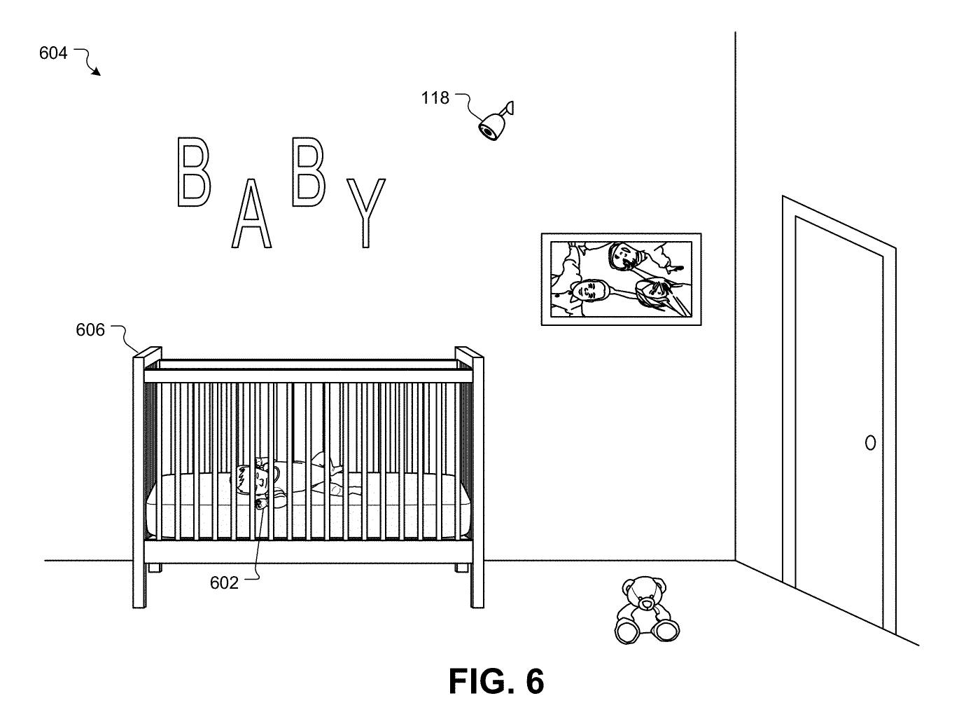

FIG. 6 illustrates an infant 602 sleeping in a sleep environment 604 and being monitored by a camera 118, according to some embodiments. The camera 118 can be one of many video cameras that are distributed throughout the smart-home environment. Although not depicted explicitly in FIG. 6, the sleep environment 604 may also include additional cameras, some of which may also be positioned to observe the infant 602. Other cameras may be used for security purposes or may be configured to observe the infant 602 in other positions and/or other locations within the sleep environment 604. In some embodiments, the camera 118 may include both a regular, visible-light camera function along with a thermal imager. The thermal imager may include a non-contact temperature measurement device that records thermal energy at pixel locations. The thermal imager can detect infrared energy that is emitted and/or reflected by any object or subject within its field-of-view. The thermal imager can convert the thermal emissions into a thermogram, or thermal image, that can be displayed and/or analyzed by a computing device. The thermal imager need not be as high resolution as the camera 118. For example, some embodiments may use a thermal imager having a 100×100 pixel resolution. This low resolution may be sufficient for detecting thermal conditions sufficiently to diagnose various problems that may be associated with the subject being monitored. Using a low resolution thermal imager can also reduce the amount of memory, processing power, and/or bandwidth required for the analysis describe below. High-resolution thermal imagers can be used to detect smaller problems at greater distances, and the final resolution of the thermal imager on the camera 118 may be selected based on a distance of the camera 118 from the infant 602.

The sleep environment 604 may include a bedroom, a closet, a nook, and/or any other location within the smart-home environment. The sleep environment may be characterized in that it includes a bed, a crib 606, a couch, a sofa, a porta-crib, a mattress, a sleeping pad, an air mattress, a covered section of the floor, and/or any other sleep-suitable location. Although the infant 602 is depicted in FIG. 6, any other monitored subject may also be monitored by the camera 118 and used in conjunction with the algorithms described in detail below. Other subjects may be monitored in sleep environments and/or any other type of monitored environment within the smart-home environment.

In this example, the camera 118 is positioned within the sleep environment 604 such that a live video feed of the infant 602 can be captured. Some embodiments may include automatic pan/tilt mounts that use computer vision algorithms to automatically train the camera 118 on the infant 602 such that the infant 602 can be located anywhere in the sleep environment 604 and still be monitored by the camera 118. In some embodiments, the pan/tilt mounts can be driven by motion detection algorithms in the camera, such that they focus on motion detected in their field-of-view. Some embodiments may use one or more cameras that are trained specifically on different locations within the sleep environment 604, such as the crib 606, the floor, a changing table, and/or the like. Each of these cameras may be activated when movement is detected within their field of view. Therefore, when the infant 602 is placed in the crib 606, the camera 118 can automatically detect the shape and/or movement of the infant 602 and determine that the infant 602 is within its field of view. Camera 118 can then automatically begin recording, analyzing, and/or transmitting a live video feed of the infant 602. Some embodiments may require a facial image of the infant 602 to detect fevers and other heat-related conditions. These embodiments may use known facial recognition algorithms to locate the face of the infant 602 within its field-of-view and pan/tilt/zoom the camera 118 accordingly to center its field-of-view on the face of the infant 602.

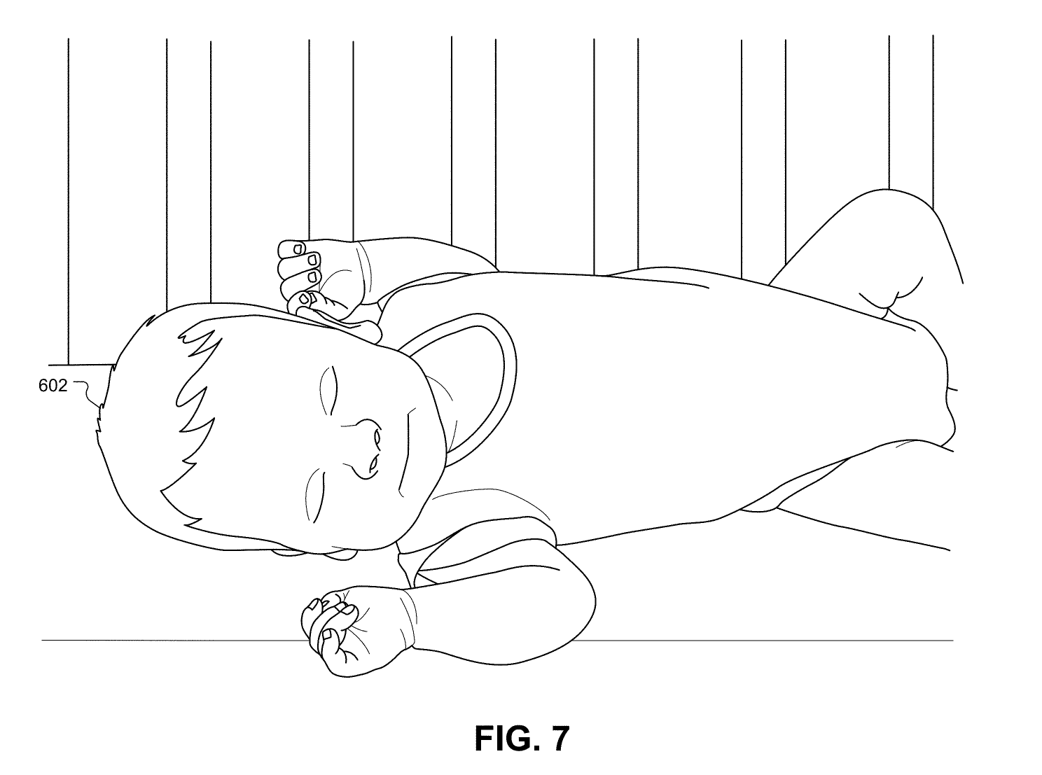

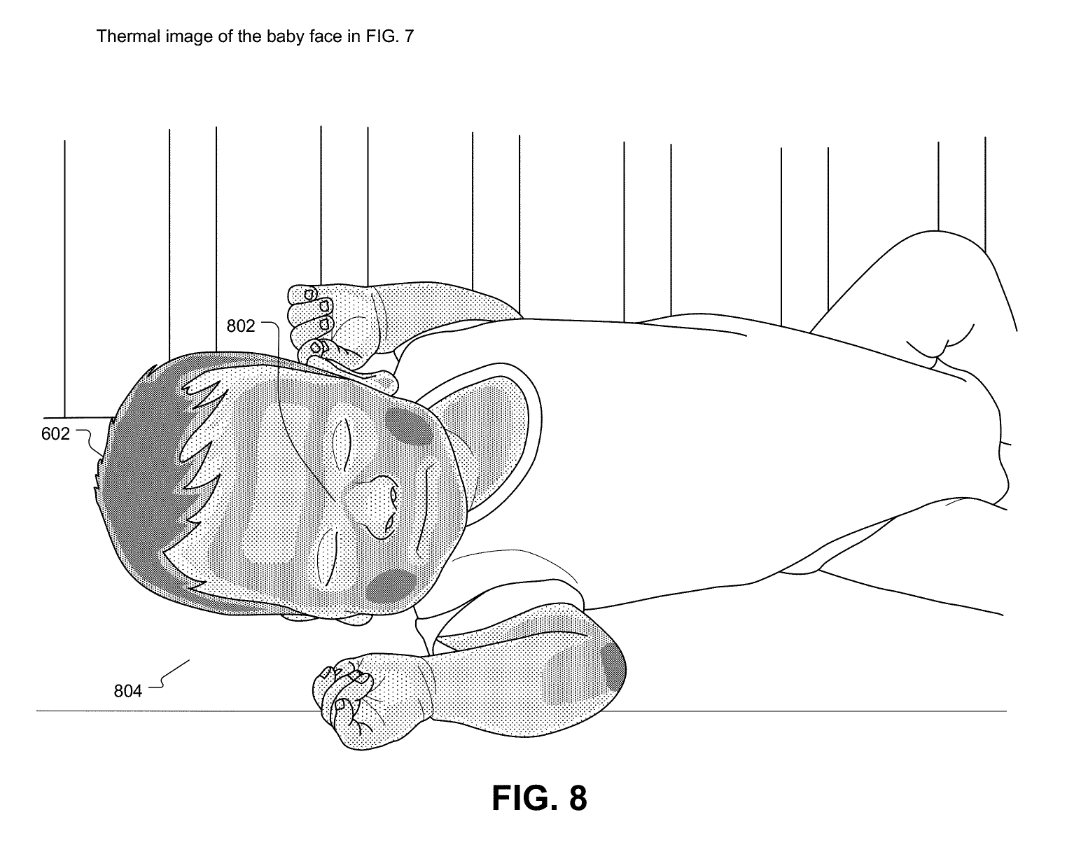

FIG. 7 illustrates a view of the infant 602 that may be received by the camera 118, according to some embodiments. In many situations, the infant 602 may be relatively immobile while sleeping. For example, the infant 602 may be confined to the crib 606 while sleeping. Therefore, the field of view of the camera 118 may be adjusted or shrunk to capture in high resolution only the area in which the infant 602 may occupy in the sleep environment. This may include automatically panning/tilting the camera to center its field of view on the infant 602. Additionally and/or alternatively, a zoom of the camera 118 can be adjusted such that the infant 602 substantially fills the field-of-view of the camera 118. For example, the zoom of the camera may be adjusted until the infant 602 fills approximately 50% of the field of view of the camera 118. In some embodiments, the automatic pan/tilt of the camera 118 can be influenced by a facial recognition algorithm that recognizes the face of the infant 702 in its field-of-view and causes the camera to center its field-of-view on the face of the infant 602. The camera 118 described in detail above includes, for example, a 4 k resolution.

FIG. 8 illustrates an image similar to that of FIG. 7 captured by the thermal imager function of the camera 118, according to some embodiments. The thermal image represents a view of the thermal heat energy emitted/reflected by the infant 602. The thermal image has the advantage of not being dependent upon absolute lighting or variations in lighting for image quality. Instead, the color bands in a facial image indicate different heat bands in the skin of the infant 602. Each individual emits different patterns of thermal energy according to their temperature and facial characteristics. The typical temperature range of the human face/body is often quite uniform on the surface of the skin, varying from 35.5° C. to 37.5° C. The thermal patterns of the infant's face 602 are derived primarily from a pattern of superficial blood vessels that reside under the skin of the infant 602. The vein and tissue structure of every face is unique for each individual, and therefore the thermal images generated of the face of each infant are also unique.

When presented in a thermal image, the slight variations in temperature on the skin of the infant 602 can be represented using different color bands. Colder portions of the skin can be represented with darker colors, such as colors closer to the blue/black end of the color spectrum. Warmer portions of the skin can conversely be represented with lighter colors, such as colors closer to the white/yellow side of the color spectrum. The full-color spectrum in the thermal image can be scaled such that it covers the expected range of temperatures visible on the skin of the infant 602. In FIG. 8, the darker/denser fill patterns of each color band are inversely proportional to the temperature measured by the thermal imager. For example, the cheeks of the infant 602 in FIG. 8 are colder than the area surrounding the eyes of the infant 602.

In some embodiments, the thermal image of the infant 602 can be used to identify the infant 602. As described above, a facial recognition technique using the thermal image can be compared to known images in a local memory and used to determine an identity for the infant 602. Some embodiments may allow users to register different infants or monitored subjects with the smart-home environment through a training process where the camera 118 automatically recognizes a subject that has not been seen before and alerts the user. The user can then provide an identifier (e.g., a name) for the new subject. This can be particularly advantageous in homes or environments with multiple children or subjects that will be monitored.

In some embodiments, a baseline thermal signature can be determined for the infant 602. Establishing a baseline thermal signature can be done in a number of different ways. In some embodiments, a baseline thermal signature can record an average thermal image of portions of the infant's exposed skin 602. First, the algorithm can identify exposed skin of the infant 602 by finding the warmer areas of the image. Exposed skin will generally emit more heat energy than clothed areas of the infant 602. The algorithm can then record an image of the exposed skin as a baseline image. During a learning interval, such as one week, two weeks, one month, etc., the baseline image can be combined/compared with subsequent images to generate an average thermal signature for the infant 602. As used herein, the term “thermal signature” can refer to any thermal characteristic of the infant 602 that may be recorded as a baseline and compared to future thermal images or characteristics. In this example, the thermal signature may be an average thermal image of the face of the infant 602, or a metric derived from the average facial image of the infant 602.

In some embodiments, a baseline thermal signature can include an estimated internal temperature of the infant 602. In some embodiments, the average thermal image of the infant 602 can be assumed to be within a normal, healthy range of internal infant temperatures. In some embodiments, an algorithm has been developed to estimate the internal temperature of the infant 602 based on the thermal image. This algorithm comprises a method that does not require contact and at a remote distance can estimate the internal body temperature of the infant 602 or any other object in the field-of-view of the camera 118. Because the surface temperature is not necessarily consistent with the internal temperature, this algorithm requires a new form of temperature analysis. Specifically, this algorithm derives a transfer function based on a distance of the camera 118 to the infant 602. The algorithm then determines an ambient temperature around the infant 602. For example, using the facial identification routine described above, the algorithm can identify an area around the perimeter of the infant 602, such as location 804. Next, the algorithm can use temperature values from the thermal imager to determine the hottest spot on the skin of the infant 602, such as location 802. Location 802 is most likely closest to the internal temperature of the infant 602. The transfer function can then be computed using this temperature differential to provide an estimate of the inter-ear temperature of the infant 602.

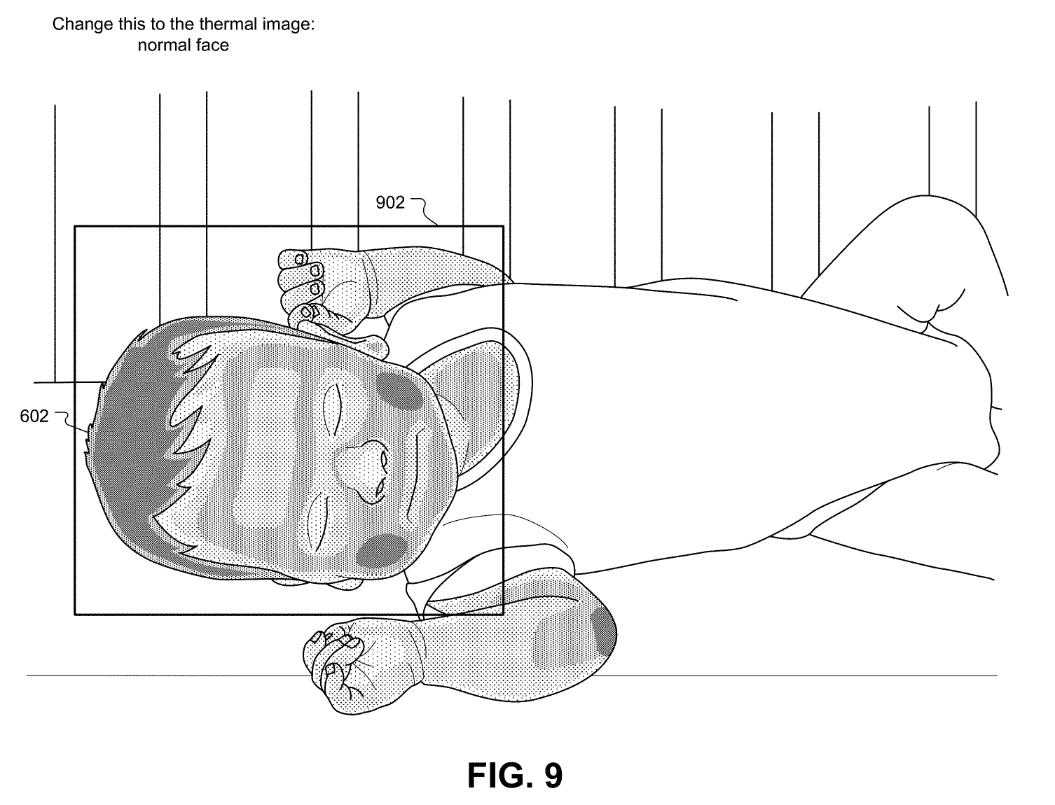

FIG. 9 illustrates a thermal view and of the infant 602 with a bounding box 902 that reduces the processing power, memory, and/or bandwidth required by the system, according to some embodiments. Some embodiments may analyze the real-time video feed of the infant 602 at the camera 118. In these embodiments, it may be advantageous to decrease the number of pixels that need to be analyzed in the full field-of-view of the camera 118. By reducing the analyzed portion of the field-of-view of the camera 118, algorithms can run faster and less memory can be used on the camera 118. This may be particularly advantageous for cameras that have relatively small processing capabilities and/or relatively limited memory storage available.

In some embodiments, the video feed of the camera can be analyzed in real time to identify a portion of each image frame that includes the face of the infant 602. A bounding box 902 can be selected that includes the face, along with a predetermined amount of each surrounding image. For example, a bounding boxing 902 can include the face at the center of the bounding box 902, and can also expand to include an additional two feet of image extending outward from the face. In other embodiments, the bounding box 902 can include the face, as well as a surrounding area that can be visually identified as a subject (e.g. the infant 602). In the example of FIG. 8, the bounding box 902 includes the face as well as the rest of the body of the infant 602. Computer vision algorithms can be used to identify objects, and these computer vision algorithms can be modified based on this particular environment to identify the shape of the infant 602 in each frame. The bounding boxing 902 can be sized such that the entire infant 602 is captured within the analyzed area for the camera 118.

In addition to bounding the area that will be analyzed by the camera 118, the system can also filter out thermal signatures that are not of interest or associated with the monitored subject. For example, some embodiments may filter out other heat signatures in the room, such as space heaters, areas surrounding heat vents, while areas that include hot-water pipes, heat-generating electronics, and other heat sources that are not associated with the infant 602. Although these other heat sources may be visible in the live video feed itself, they can be filtered from the thermal image such that they do not interfere with the comparison algorithm described below for determining heat-related characteristics of the infant 602.

In some embodiments, the resolution of the captured video feed can be altered based on the bounding box 902. For example, the camera can record and transmit a lower resolution video image for portions of the image outside of the bounding box 902, while preserving a high-resolution digital image for portions of the video feed that are inside the bounding box 902. This can simplify the video processing of a thermal-signature-matching algorithm, decrease the bandwidth required to transmit the live video feed in real time, reduce the amount of processing power required to process the live video feed, and/or reduce the amount of memory required to store images and information associated with the live/thermal video feeds.

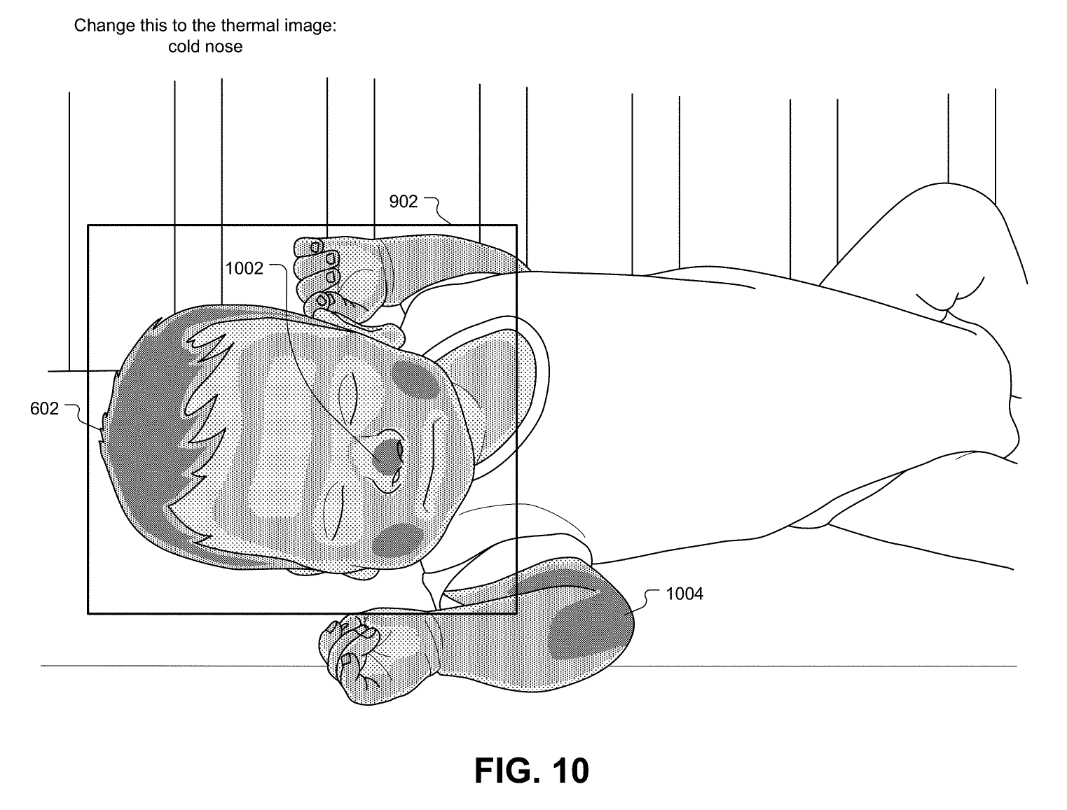

FIG. 10 illustrates a thermal image that can diagnose an infant 602 that is to cold, according to some embodiments. In this example, certain areas of the image may be colder than the recorded baseline thermal signature. For example, the nose 1002 of the infant 602 may appear to be a darker color in the thermal image than in the baseline image. Similarly, an exposed arm 1004 of the infant 602 may appear to be a darker color than in the baseline image. When certain areas of the infant 602 are colder than the baseline image, this can indicate that the infant 602 is not warm enough. As described below, this situation can generate an alert for a user indicating that the infant 602 may be cold. Additionally or alternatively, this can generate automatic control signals for the smart-home environment to change the environmental characteristics of the area surrounding the infant 602. For example, when the camera 118 detects areas of the infant 602 that are colder than normal, the smart-home environment can generate commands for a thermostat to increase the setpoint temperature of the room of the infant 602.

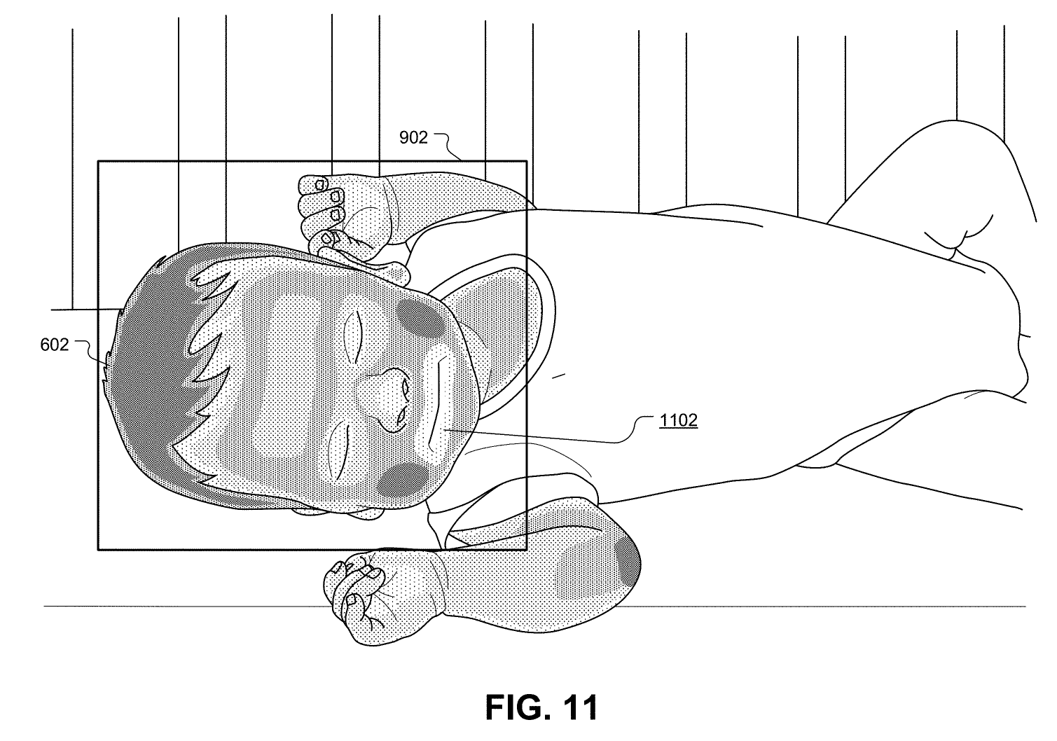

FIG. 11 illustrates a thermal image that can be used to diagnose an infant 602 who is teething, according to some embodiments. When the infant 602 is teething, excessive heat may be generated around the mouth of the infant 602. This heat can be visible to the thermal imager. In FIG. 11, area 1102 around the mouth of the infant 602 is lighter in color than normal. As was the case above, the current thermal image of the infant 602 can be compared to a baseline image from a baseline thermal signature, and differences can be isolated and used to diagnose certain conditions. Above, when certain exposed areas of the infant 602 are colder than the baseline image, it can indicate that the room of the infant 602 is to cold or that additional clothes, blankets, coverings, etc., should be placed on the infant 602. When certain areas of the infant 602 are warmer than the baseline image, these can be used to diagnose, in some cases, medical conditions. When a particular isolated area of the infant 602 is warmer than normal, this can indicate different medical conditions, such as infections, or in the example of FIG. 11, teething. The algorithm can compare the thermal image of a baseline thermal signature with a current thermal image and identify areas that are warmer by a predetermined threshold amount. As described below, this can generate an alert or informational indication that can be sent to the mobile device of a parent or other user.

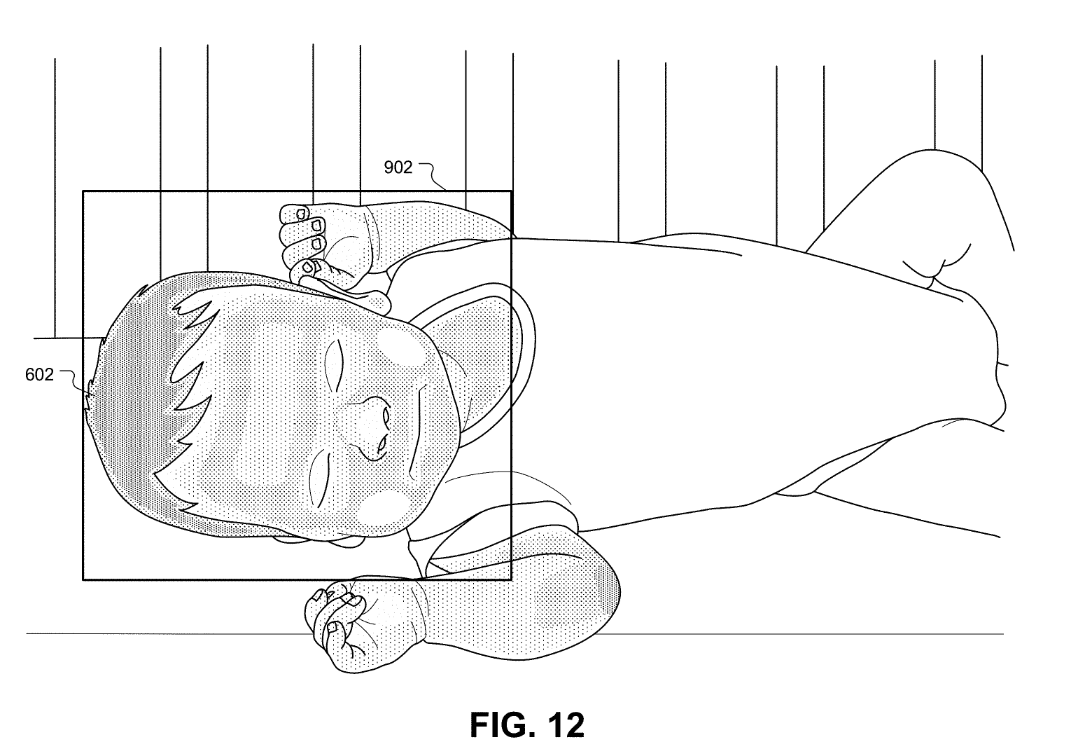

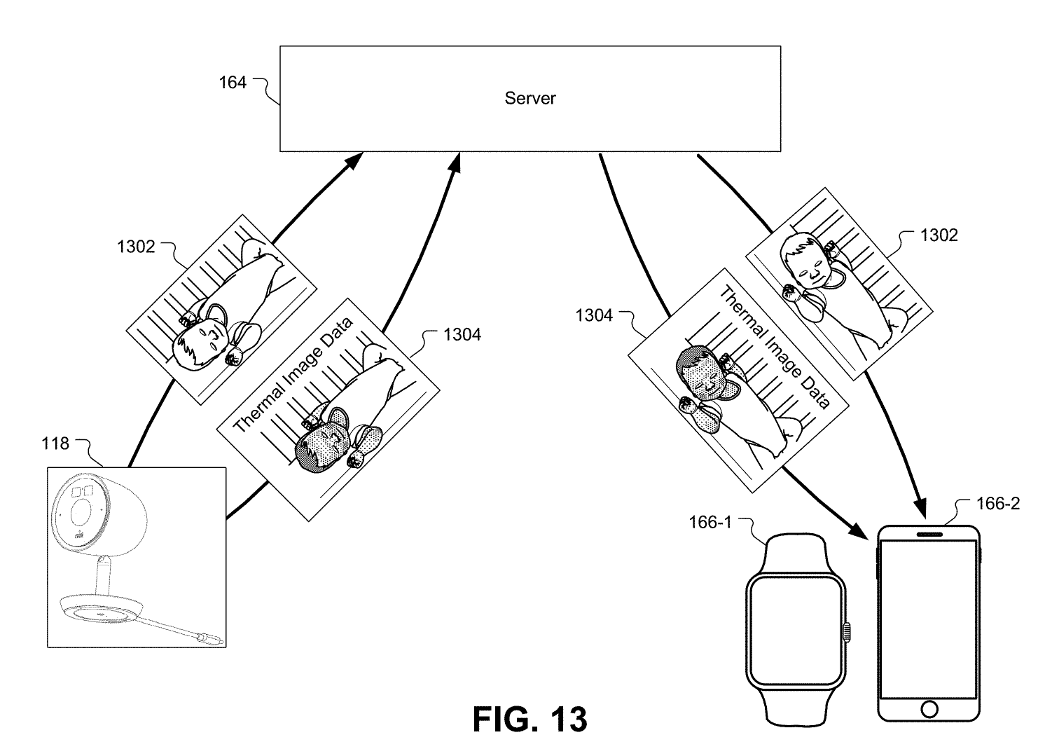

FIG. 12 illustrates a thermal image that can be used to diagnose an infant 602 who is suffering from a fever, according to some embodiments. When the infant 602 has a fever, the exposed skin in the thermal image, particularly the skin of the face of the infant 602, will be lighter in color, indicating that the infant is warmer than normal. A fever condition can be diagnosed by comparing the current image to a thermal image of the baseline thermal signature for the infant 602. When a temperature differential is detected above a predetermined threshold amount (e.g., 2°, 3°, etc.) a fever diagnosis can be communicated to a parent or other user. In addition to calculating a temperature differential by comparing thermal images, an internal temperature can be estimated for the infant 602. The method described above using a transfer function that incorporates the distance from the camera to the infant 602, the ambient room temperature, and a warmest estimated skin temperature can be used to estimate a current internal temperature of the infant 602. This estimated temperature can be compared in some cases to the baseline temperature to ensure that the diagnosis is correct.

FIG. 13 illustrates a system diagram for processing and transmitting images between the camera 118 and a user's mobile device 166, according to some embodiments. In this simplified diagram, some well-understood electronic components may be omitted, such as a power outlet, an ethernet cable, a Wi-Fi home router, and so forth. In some embodiments, the camera 118 can capture a live video feed 1302 of a monitored subject and perform processing operations on the camera 118 itself. As described above, the camera 118 may include one or more processors and one or more memory devices that can be used for executing predefined algorithms on the individual frames of the live/thermal video feed. In the example described above, this may include analyzing a thermal image of the infant 602 to diagnose environmental problems or medical conditions. The camera 118 can send results of this diagnosis to the server 164. Additionally or alternatively, the camera 118 can also send the thermal image data 1304 along with the live video feed 1302 to the server 164.

In some embodiments, only the live video feed 1002 needs to be captured and transmitted from the camera 118. A remote server 164 that is accessible over the Internet through a home Wi-Fi router can also perform the image processing algorithms on the live video feed 1002 and/or the thermal image data 1304. In these embodiments, the camera 118 can be a high-resolution camera that does not necessarily need to include processors and memories sufficient to execute the motion detection algorithms described above. The server 164 may include a smart-home device monitoring server that collects monitoring information from smart-home devices in the smart-home environment. The server 164 may also provide data synchronization and/or software upgrades to each of the smart-home devices, including the camera 118, in the smart-home environment. The server 164 can be owned and/or operated by a manufacturer of the smart-home devices, including the camera 118. The server 164 may include a dedicated user account for each smart-home environment (e.g., each home). The server 164 may be referred to herein as a smart-home device monitoring server. The server 164 may also be in communication with computer systems of other entities, such as a utility provider computer system (e.g., an energy utility), a law-enforcement computer system, an emergency-response computer system, and so forth. The server 164 may also include memory locations assigned to each particular user account where a historical record of the live video feed 1002 may be stored and/or archived for later retrieval by the user of the account.

The server 164 can transmit the live video feed 1002 and the thermal image data 1304, along with any alerts, indications, and/or diagnoses calculated at the camera 118 and/or the server 164 to a mobile device 166 of the user associated with the account on the server 164. The mobile device 166 may include a smart watch 166-1, a smartphone 166-2, a laptop computer, a tablet computer, a desktop computer, a personal digital assistant (PDA), an on-board car computer system, a digital home assistant (e.g., Google Home®), and/or any other computing device. In some embodiments, the live video feed 1002 and thermal image data 1304 can be transmitted directly from the camera 118 to the mobile device 166 without passing through the server 164, but rather through a local wireless network, such as Bluetooth® network or a proprietary smart-home network (e.g., Thread®). Some embodiments may also transmit only the live video feed 1002 and/or the thermal image data 1304 to the mobile device 166 and allow the mobile device 166 to process the live video feed 1002 and/or thermal image data 1304 to diagnose environmental conditions or medical conditions for the infant 602. Therefore, the operations described herein for analyzing the thermal image data 1304 and generating indications, alerts, and/or diagnoses can be performed at the camera 118, the server 164, the mobile device 166, and/or any other processing system that is part of the smart-home environment.

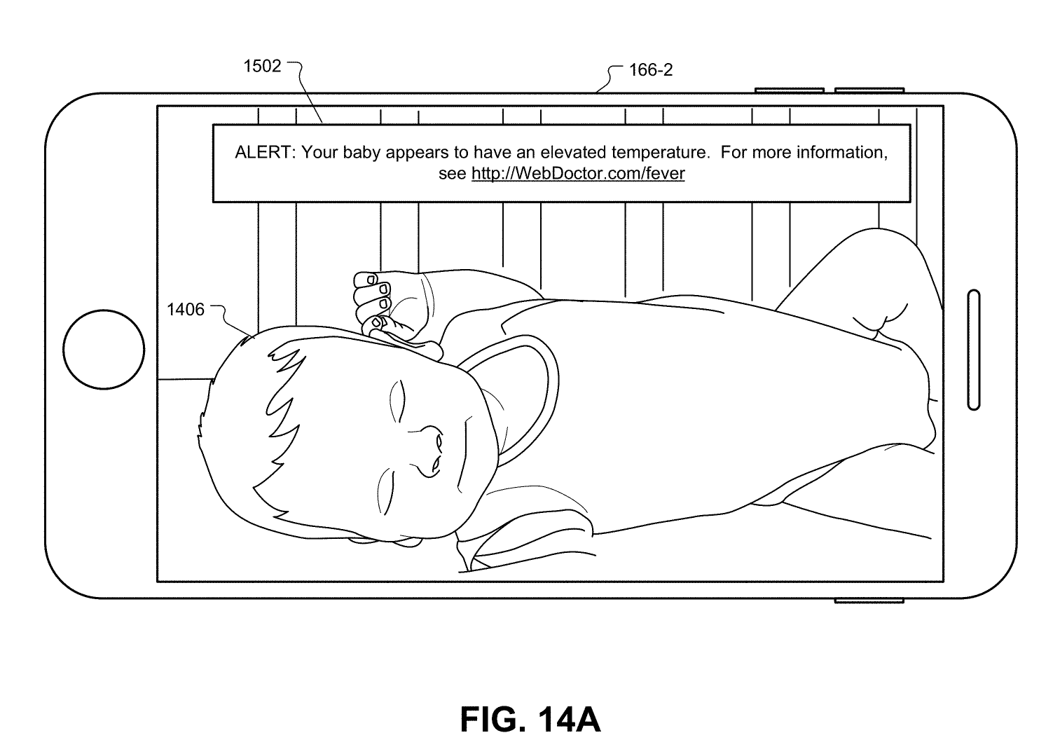

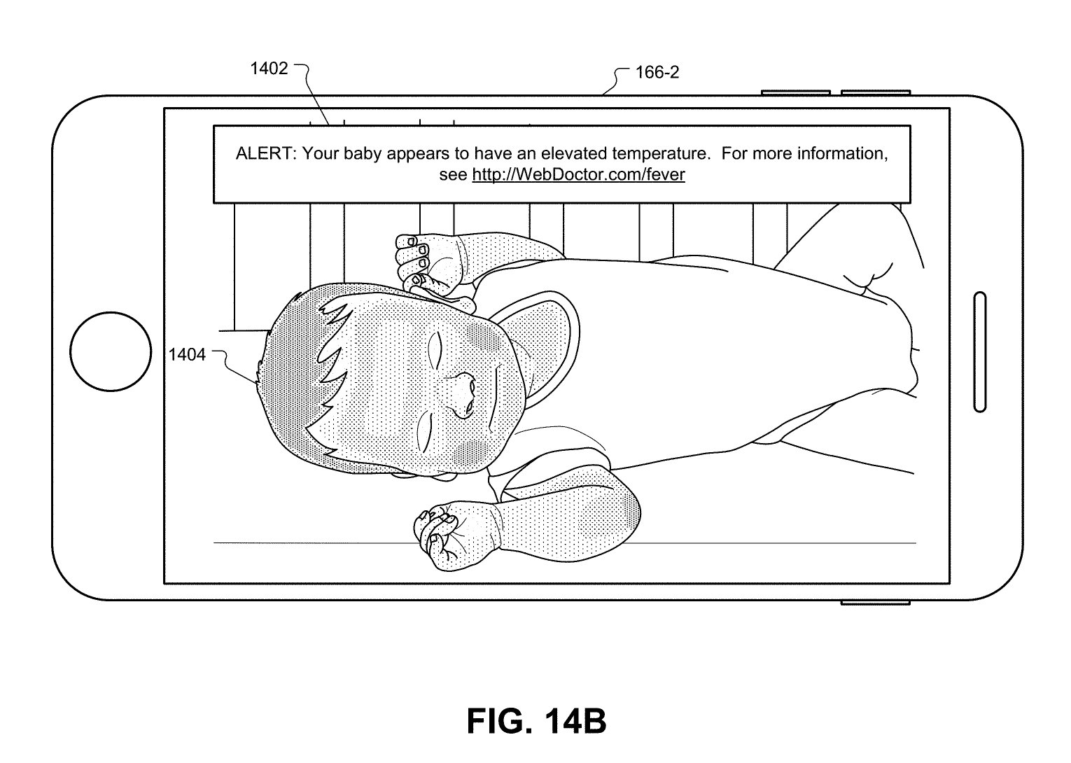

FIG. 14A illustrates a representation of the live video feed 1406 displayed on a mobile device 166-2, according to some embodiments. The live video feed 1406 can be displayed on the screen of the mobile device 166-2 as the user monitors the infant 602. In some cases, the infant 602 may be monitored on the mobile device 166-2 for an extended period of time, where real-time video is displayed to the user. This can be done to enhance the emotional connection between the user and the infant through the mobile device 166-2. For example, a parent who needs to be away from the infant during the day can log into the server 164 using the mobile device 166-2 and watch real-time video of the infant.

In some cases, the user can monitor the infant to watch for medical conditions such as fever, infection, teething, being too hot, being too cold, and so forth. While normal video streams of previous systems in the art would make it difficult or impossible to visually see or detect these medical conditions, the camera system and thermal imager described above can make these medical conditions readily apparent to an observer of the mobile device 166-2. In addition to simply displaying the real-time video feed 1406, the mobile device 166-2 can also display visual/audio warnings or status messages for any of the medical conditions detected above. In the example of FIG. 14 A, an alert 1402 is displayed on the screen indicating that the baby appears to have an elevated temperature. The alert may include a vibration, a sound, and/or color encodings that indicate the severity of the alert. For example, a temperature elevated by more than 4° can generate an alert 1402 that is colored red and generates an audible alarm and/or vibration of the mobile device 166-2. Some embodiments may also generate indications that include additional information based on the condition that is diagnosed. For example, if the thermal image indicates that the infant has an elevated temperature, the alert 1402 can include information describing infant fevers, home remedies that can be applied, local doctor information, links to additional information on the Internet, and/or any other information that would be useful for treating the condition. It should be noted that some embodiments do not generate alerts that provide additional information, medical advice, and/or links to additional medical information. These embodiments may instead direct the user to contact a medical professional.

FIG. 14B illustrates a representation of the thermal video feed 1404 as it is displayed on a mobile device 166-2. FIG. 14B is similar to FIG. 14A, the difference being that the thermal video feed 1404 has replaced the live video feed 1406. Seeing the actual thermal video feed 1404 can be useful for providing additional information about the environmental condition or medical condition determined by the smart-home environment. For example, by seeing the thermal video feed 1404, a parent can immediately determine that the infant is swaddled too tightly, has too many blankets, or is not sufficiently covered. This can help the parent or user distinguish between a fever condition and an infant who is covered with too many clothes, blankets, etc.

The thermal video feed 1404 can also be used in conjunction with any links to additional information in the alert 1402. For example, some embodiments can transmit thermal images of monitored subjects to the server 164. When a particular condition is detected, the user can select a link provided in the alert 1402 to see other images stored at the server 164 such that they can visually compare these images to the current thermal image of their own infant. For example, by seeing thermal images of other infants with a fever, the parent can have greater confidence in the diagnosis based on the thermal image that they see on their own mobile device 166-2. Alternatively, if the camera 118 or smart home device 166-2 indicates that the infant has a fever, seeing additional thermal images may help the parent identify environmental differences that may account for the raised temperature of the infant rather than a fever.

In some embodiments, the alert 1402 may also include an option to send the thermal image transmitted to the mobile device 166-2 to a selected healthcare provider. By providing the estimated internal temperature of the infant as well as a thermal image of the infant, a doctor/nurse may have additional information needed to help diagnose the child and prescribe a treatment regimen without requiring the parent to actually bring the child to a healthcare facility.

In some embodiments, the server 164 or another computing device in the smart-home environment can store a library of historical thermal images of the infant that can be retrieved and compared over time. For example, when taking the infant to a medical professional, the parent can grant access to a history of thermal images and estimated temperatures. Thus, the medical professional can see how the medical condition of the infant has progressed over time. By comparing a history of images, the alert 1402 can indicate to a user that the infant's fever is beginning to subside and their temperature is beginning to decrease. Similarly, a history of images can reveal that an infection or teething situation is beginning to subside rather than increase. The alert 1402 can incorporate these findings and indicate that the infant's condition appears to be improving. For example, an alert can be provided not only when a fever is detected, but also when the child's temperature begins to decrease by a predetermined threshold amount (e.g. 1°, 2°, degree, etc.), indicating that the fever is beginning to break.

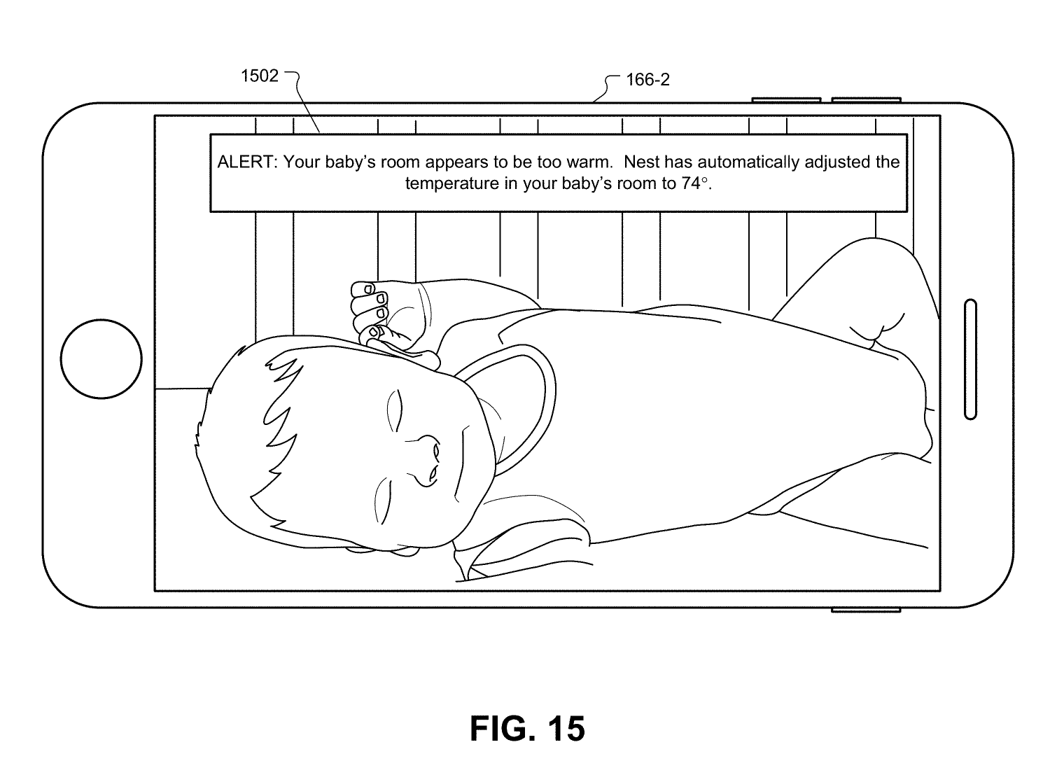

FIG. 15 illustrates an indication 1502 that indicates automatic environmental changes that have been executed by the smart-home environment based on the thermal images received from the camera 118, according to some embodiments. Indication 1502 provides both a diagnosis of a problem that was detected via the thermal images of the infant, as well as corrective action that was taken by the smart-home environment to remedy the situation. In this example, the alert 1502 indicates that the babies room appeared to be too warm. It also indicates that the smart-home environment has automatically adjusted the temperature setpoint of the thermostat in the infant's room to a lower temperature. In some embodiments, the alert 1502 may include user input options that allow the user to approve the environmental change, override the environmental change, or input a different, for example, setpoint temperature for the HVAC system.

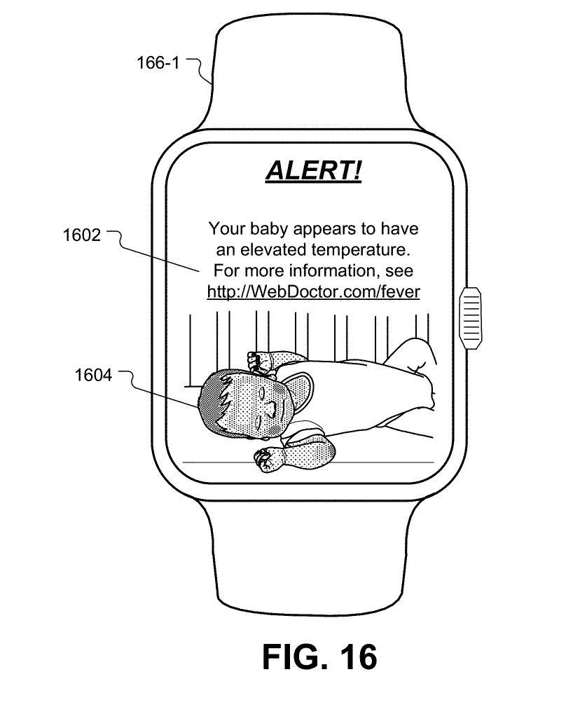

FIG. 16 illustrates an alternative visual representation of an alert on a mobile device 166-1, according to some embodiments. In this embodiment, the mobile device 166-1 may include a smart watch or other piece of wearable technology. This alert 1602 is similar to the alert illustrated in FIG. 14A indicating that the infant appears to have an elevated temperature. The mobile device 166-1 may also include a thermal image or video feed 1604 of the monitored subject. Alternatively or additionally, the mobile device 166-1 may include the live video feed. In any embodiment, mobile devices 166 may allow the user to toggle back and forth between the images from the thermal video feed and the images from the live video feed.

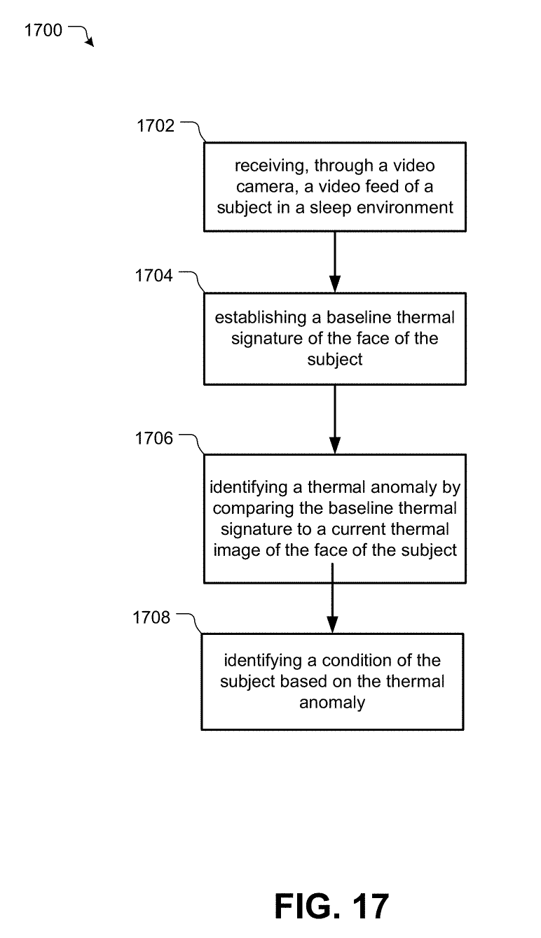

FIG. 17 illustrates a simplified flowchart 1700 of a method for monitoring physical characteristics of subjects in sleep environments. The method may include receiving, through a video camera, a video feed of a subject in a sleep environment (1702). The video camera may comprise a thermal imaging camera, and the video feed may include thermal images of a face of the subject. As described above, the video camera may be automatically or manually adjusted to focus on a face of the subject, along with a surrounding region of the subject. The area of the field-of-view of the video camera can have the resolution adjusted to provide less information in areas of the image that are not of interest. The method may additionally include establishing a baseline thermal signature of the face of the subject (1704). The baseline thermal signature may include an estimated temperature, a thermal image, an average thermal image, and estimated internal temperature, and so forth. The method may also include identifying a thermal anomaly by comparing the baseline thermal signature to a current thermal image of the face of the subject (1706). The thermal anomaly may be an identification of a temperature difference between the current thermal image and the baseline thermal signature. The method may also include identifying a condition of the subject based on the thermal anomaly (1708). Identifying the condition may include a diagnosis of a suspected medical condition, such as a fever, detecting an elevated temperature, detecting a teething situation, detecting an infection, and so forth. The condition may also be an environmental condition, such as a room temperature that is too hot or too cold, or situations where the subject has too many clothes/blankets, and so forth. Some embodiments may also generate alerts that are sent to a mobile device that provide additional information, allow the user to observe the thermal image of the subject, automatically adjust environmental conditions, retrieve additional information from a database or the Internet, contact medical professionals, and so forth.

It should be appreciated that the specific steps illustrated in FIG. 15 provide particular methods of monitoring physical characteristics of subjects in sleep environments according to various embodiments of the present invention. Other sequences of steps may also be performed according to alternative embodiments. For example, alternative embodiments of the present invention may perform the steps outlined above in a different order. Moreover, the individual steps illustrated in FIG. 15 may include multiple sub-steps that may be performed in various sequences as appropriate to the individual step. Furthermore, additional steps may be added or removed depending on the particular applications. One of ordinary skill in the art would recognize many variations, modifications, and alternatives.

In the foregoing description, for the purposes of explanation, numerous specific details were set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the foregoing description to provide a thorough understanding of the embodiments. However, it will be understood by one of ordinary skill in the art that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of monitoring physical characteristics of subjects in sleep environments, the method comprising:
receiving, through a video camera, a video feed of a subject in a sleep environment, wherein the video camera comprises a thermal imaging camera, and wherein the video feed comprises thermal images of a face of the subject;
establishing a baseline thermal signature of the face of the subject;
identifying a thermal anomaly by comparing the baseline thermal signature to a current thermal image of the face of the subject; and
identifying a condition of the subject based on the thermal anomaly.

2. The method of claim 1, further comprising analyzing the video feed to identify the face of the subject using a facial recognition algorithm.

3. The method of claim 1, further comprising analyzing the video feed to identify the face of the subject by matching a thermal signature to a pre-recorded thermal signature corresponding to the subject.

4. The method of claim 3, further comprising causing the video camera to zoom and focus on the face of the subject after the face of the subject is recognized.

5. The method of claim 1, wherein establishing a baseline thermal signature of the face of the subject comprises averaging a plurality of facial images from a plurality of sleep sessions.

6. The method of claim 1, wherein establishing a baseline thermal signature of the face of the subject comprises receiving a thermal signature from a signature database from a remote server.

7. The method of claim 1, wherein establishing a baseline thermal signature of the face of the subject comprises determining a thermal signature of the face within a normal temperature range.

8. The method of claim 1, further comprising determining a temperature of the face of the subject based on the current thermal image of the face of the subject.

9. The method of claim 8, wherein determining the temperature of the face of the subject uses a transfer function based on a distance of the video camera to the face of the subject.

10. The method of claim 9, wherein determining the temperature of the face of the subject comprises determining a temperature around a perimeter of the subject and a point on the face of the subject having the highest identified temperature.

11. A system for monitoring physical characteristics of subjects in sleep environments, the system comprising:
a video camera;
one or more processors; and
one or more memory devices comprising instructions that, when executed by the one or more processors, cause the one or more processors to perform operations comprising:
receiving, through the video camera, a video feed of a subject in a sleep environment, wherein the video camera comprises a thermal imaging camera, and wherein the video feed comprises thermal images of a face of the subject;
establishing a baseline thermal signature of the face of the subject;
identifying a thermal anomaly by comparing the baseline thermal signature to a current thermal image of the face of the subject; and
identifying a condition of the subject based on the thermal anomaly.

12. The system of claim 11, wherein the operations further comprise analyzing the video feed to identify the face of the subject using a facial recognition algorithm.

13. The system of claim 11, wherein the operations further comprise analyzing the video feed to identify the face of the subject by matching a thermal signature to a pre-recorded thermal signature corresponding to the subject.

14. The system of claim 13, wherein the operations further comprise causing the video camera to zoom and focus on the face of the subject after the face of the subject is recognized.

15. The system of claim 11, wherein establishing a baseline thermal signature of the face of the subject comprises averaging a plurality of facial images from a plurality of sleep sessions.

16. The system of claim 11, wherein establishing a baseline thermal signature of the face of the subject comprises receiving a thermal signature from a signature database from a remote server.

17. The system of claim 11, wherein establishing a baseline thermal signature of the face of the subject comprises determining a thermal signature of the face within a normal temperature range.

18. The system of claim 11, wherein the operations further comprise determining a temperature of the face of the subject based on the current thermal image of the face of the subject.

19. The system of claim 18, wherein determining the temperature of the face of the subject uses a transfer function based on a distance of the video camera to the face of the subject.

20. The system of claim 19, wherein determining the temperature of the face of the subject comprises determining a temperature around a perimeter of the subject and a point on the face of the subject having the highest identified temperature.
